(19) United States
(12) Patent Application Publication
(10) Pub. No.: US 2026/0044541 A1
(43) Pub. Date: Feb. 12, 2026

(54) Method and System for Processing Artificial Intelligence User Requests

(71) Applicant: Vijay Madisetti, Alpharetta, GA (US)

(72) Inventors: Vijay Madisetti, Alpharetta, GA (US); Arshdeep Bahga, Chandigarh (IN)

(73) Assignee: Vijay Madisetti, Alpharetta, GA (US)

(21) Appl. No.: 19/365,469

(22) Filed: Oct. 22, 2025

Related U.S. Application Data
(63) Continuation-in-part of application No. 18/965,072, filed on Dec. 2, 2024, now Pat. No. 12,468,745.
Application No. 18/965,072 is a continuation of application No. 18/391,127, filed on Dec. 20, 2023, now Pat. No. 12,169,513.
Application No. 18/391,127 is a continuation of application No. 18/348,692, filed on Jul. 7, 2023, now Pat. No. 12,001,462.
(60) Provisional application No. 63/463,913, filed on May 4, 2023.
(60) Provisional application No. 63/469,571, filed on May 30, 2023.
(60) Provisional application No. 63/889,980, filed on Sep. 29, 2025.

(51) Int. Cl. G06F 16/3329; G06F 40/284

(52) U.S. Cl. CPC G06F 16/3329; G06F 40/284

(57) ABSTRACT

Systems and methods for processing artificial intelligence user requests including receiving a user input from a user device, performing a routing analysis on the user input on multiple characteristics, making a routing decision based on the routing analysis to send the user input to one or both of an experiential reasoning agent model and an analytical reasoning model, routing the user input to at least one of the experiential reasoning agent model and the analytical reasoning model responsive to the routing decision, receiving one or more outputs from at least one of the experiential reasoning agent model and the analytical reasoning model, generating a final result by performing a result validation procedure on the one or more outputs, and transmitting the final result to the user device.

### RELATED APPLICATIONS

This application claims priority under 35 U.S.C. § 119 (e) of U.S. Provisional Patent Application Ser. No. 63/889,980 (Attorney Docket No. 3026.00249) filed on Sep. 29, 2025 and titled BPUs-New Models for Artificial General Intelligence. This application also is a continuation-in-part application of and claims priority under 35 U.S.C. § 120 of U.S. patent application Ser. No. 18/965,072 (Attorney Docket No. 3026.00201) filed on Dec. 2, 2024 and titled Method and System for Multi-Level Artificial Intelligence Supercomputer Design, which in turn is a continuation application of and claims priority under 35 U.S.C. § 120 of U.S. patent application Ser. No. 18/391,127, now U.S. Pat. No. 12,169,513, issued Dec. 17, 2024 (Attorney Docket No. 3026.00165) filed on Dec. 20, 2023 and titled Method and System for Multi-Level Artificial Intelligence Supercomputer Design, which in turn is a continuation application of and claims priority under 35 U.S.C. § 120 of U.S. patent application Ser. No. 18/348,692, now U.S. Pat. No. 12,001,462, issued Jun. 4, 2024 (Attorney Docket No. 3026.00143) filed on Jul. 7, 2023 and titled Method and System for Multi-Level Artificial Intelligence Supercomputer Design, which in turn claims priority under 35 U.S.C. § 119 (e) of U.S. Provisional Patent Application Ser. No. 63/463,913 (Attorney Docket No. 3026.00138) filed on May 4, 2023 and titled New Tools for Document Analysis in CatchUp, and U.S. Provisional Patent Application Ser. No. 63/469,571 (Attorney Docket No. 3026.00141) filed on May 30, 2023 and titled Multilevel AI PSupercomputer Design. The contents of these applications are incorporated herein by reference.

### FIELD OF THE INVENTION

The present invention relates to hybrid processing artificial intelligence systems and methods that integrate experiential reasoning models with analytical reasoning models through an intelligent state machine controller to achieve artificial general intelligence capabilities.

### BACKGROUND

Large Language Models (LLMs) are generative Artificial Intelligence (AI) models which are trained on limited amounts of data and can perform language processing tasks (with multimodal inputs-text, and more recently, image inputs as in Microsoft's Kosmos-1) and generate human-like text (and associated multimedia material, like images, video and advertisements). LLMs have many parameters (from millions to billions). LLMs can capture complex patterns in language and produce text that closely resembles human language.

The high-level goal of an LLM is to predict the text (and other multimedia material) that is likely to come next in a sequence. The applicants recognize that LLMs are a type of generative AI that is in usually different from traditional machine learning and AI applications. LLM also stands for Learning with Limited Memory and implies that LLM's are closely tied to their training data and make decisions based on the limited amount of data. Both generative AI and LLM generate content, but LLM does it in a manner that improves computational and memory efficiency.

Traditional machine learning type algorithms focus on analysis, such as statistical regression or clustering, and are usually again different from Generative AI and LLMs, which focus on generating content. LLMs have immediate practical implication in generation of new content that matches associated or preceding/future content in an optimized manner, such as legal briefs or computer code, based on training with a limited amount of data, such as existing briefs or code, both from private and public sources. In this invention, we focus on LLM models as the primary focus of these improvements, though we do not disclaim other AI models, unless expressly done as part of the claims.

LLMs are created with complex architectures such as transformers, encoders and decoders. LLMs, typically, use a technique of natural language processing called Tokenization that involves splitting the input text (and images) and output texts into smaller units called tokens. Tokens can be words, characters, sub-words, or symbols, depending on the type and the size of the model. Tokenization helps to reduce the complexity of text data, making it easier for LLMs to process and understand data thus reducing the computational and memory costs. Another important component of an LLM is Embedding, which is a vector representation of the tokens. The Encoder, within the Transformer architecture, processes the input text and converts it into a sequence of vectors, called embeddings, that represent the meaning and context of each word. The Decoder, within the Transformer architecture, generates the output text by predicting the next word in the sequence, based on the embeddings and the previous words. LLMs use Attention mechanisms that allow the models to focus selectively on the most relevant parts of the input and output texts, depending on the context of the task at hand, thus capturing the long-range dependencies and relationships between words.

LLMs are designed to learn the complexity of the language by being pre-trained on vast amounts of text (and multimedia) data from sources such as Wikipedia, books, articles on the web, social media data and other sources. The training procedure can be decomposed into two stages:
1. Pre-training on a large amount of unlabeled plain text; and
2. Supervised fine-tuning

Through training on limited amounts of data, the models are able to learn the statistical relationships between words, phrases, and sentences and other multimedia content. The trained models can then be used for generative AI applications such as Question Answering, Instruction Following, Inferencing, for instance, where an input is given to the model in the form of a prompt and the model is able to generate coherent and contextually relevant responses based on the query in the prompt.

Popular LLM models include GPT (Generative Pre-trained Transformer), BERT (Bidirectional Encoder Representations from Transformers), BART (Bidirectional and Auto-Regressive Transformers) and PaLM (Pathways Language Model). See, for example, public domain websites, such as openai.com or bard.google.com for more information as to how a person of ordinary skill in the art may use these models. Public domain and company-specific LLMs, such as GPT4All, MiniGPT4, RMKV, BERT, MPT-7B, Kosmos-1 (which accepts image and multimodal inputs), YaLM, are also available for wide use, as for example, described in medium.datadriveninvestor.com/list-of-open-source-large-language-models-llms-4eac551bda2e.

Current AI generative models and LLMs require super-computing efforts to compute results and an efficient way to improve response times, accuracies, and reduce computational load is required to improve both cost and scalability and expandability of existing AI models and their use.

LLMs learn statistical patterns and correlations present in their training data through self-supervised learning objectives, typically predicting subsequent tokens given preceding context. Through this training process, LLMs develop internal representations capturing syntactic structures, semantic relationships, and reasoning patterns implicit in human-generated text. More recent LLMs demonstrate improved capabilities in tasks including conversational interaction, content generation, code synthesis, translation, summarization, and question answering.

However, LLMs possess fundamental architectural limitations that prevent them from achieving artificial general intelligence (AGI). Current LLMs operate exclusively in the domain of linguistic representations. LLMs process and generate sequences of discrete tokens (words, subwords, or characters) without direct access to the physical, mathematical, or causal structures underlying the phenomena described in text.

Current LLMs suffer from what may be characterized as the “flat world” problem: their understanding of reality is fundamentally two-dimensional, confined to the plane of linguistic descriptions rather than extending into the multi-dimensional space of physical reality. This limitation manifests in several deficiencies having substantial impact on their usefulness.

LLMs lack intrinsic understanding of fundamental physical concepts including gravity, inertia, momentum, force, energy, mass, and basic mechanics. When presented with problems involving physical systems, LLMs rely exclusively on textual descriptions encountered during training rather than on computational models based on physical laws. For example, an LLM may read thousands of documents describing aircraft flight but possesses no internal model of aerodynamic principles such as lift, drag, thrust, and weight, nor can it compute these forces from first principles. They also lack information about certain boundary conditions that could occur, for example, certain failure conditions.

While LLMs can identify correlations present in their training data through statistical pattern matching, they consistently fail to accurately distinguish correlation from causation. This limitation becomes critical when reasoning about cause-and-effect relationships governed by physical laws, chemical reactions, biological mechanisms, or economic principles rather than by statistical co-occurrence in text.

LLMs demonstrate weak capabilities in three-dimensional spatial reasoning and in predicting temporal evolution of dynamical systems. They cannot reliably reason or explain about geometric relationships, certain temporal relations, spatial configurations, or how physical systems change over time according to differential equations or other mathematical models of dynamics.

LLMs lack awareness of fundamental conservation principles that constrain all physical systems, including conservation of mass, energy, momentum, angular momentum, and charge. This absence leads to generation of outputs that may be linguistically coherent but violate basic physical constraints, producing scenarios that are thermodynamically impossible, mechanically unstable, or energetically infeasible. Current LLMs possess no mechanism to verify whether their generated outputs comply with real-world physical constraints, engineering safety margins, regulatory standards based on physical limits, or mathematical requirements for system stability and feasibility. While LLMs can manipulate numerical values presented as text tokens, they lack the precision and rigor of dedicated mathematical computation engines. They cannot reliably perform complex numerical calculations, solve systems of equations, optimize objective functions subject to constraints, or integrate differential equations governing system dynamics.

Large Language Models trained exclusively on textual data possess only a two-dimensional understanding of reality confined to linguistic descriptions. They comprehend statistical patterns and correlations between words but lack intrinsic models of how the physical world operates according to scientific principles. These models demonstrate no computational representation of physical laws governing motion, forces, energy, thermodynamics, electromagnetism, and matter. They cannot validate generated solutions against physical constraints, engineering limits, and safety margins, nor can they perform precise numerical calculations, solve differential equations, or optimize constrained objective functions. This limitation is analogous to training a pilot exclusively by having them read flight manuals and aviation literature without ever experiencing actual flight physics, understanding aerodynamics through mathematical models, or learning to compute flight parameters from first principles.

Current AI systems lack sophisticated mechanisms for determining when to rely on experiential pattern-matching versus when to employ rigorous analytical computation. Human experts develop intuition about when to trust experience-based heuristics and when to perform detailed mathematical analysis, but existing AI systems possess no equivalent metacognitive capability. There exists no dynamic routing mechanism between fast heuristic processing and slow analytical processing based on task characteristics, no ability to assess contextual factors such as urgency, risk, complexity, domain, and constraints to select appropriate processing modes, and no learned merge strategies for combining outputs when both experiential and analytical approaches are employed. The absence of adaptive algorithms that learn from experience which processing strategies work best for different task types represents a critical gap in current AI architectures.

Even when both language models and analytical models exist as separate systems, current approaches lack effective integration mechanisms. There is no executive function analogous to human meta-cognition that can determine which model or combination of models is appropriate for a given task based on learned performance characteristics, combine outputs from both models in a coherent manner that leverages their complementary strengths, or resolve conflicts and inconsistencies when models produce contradictory results. Current systems provide no transparency regarding which processing modes contributed to final outputs and how they were combined, making it impossible to understand or verify the reasoning process.

These technical limitations impose severe practical constraints on AI system deployment across critical application domains. AI systems cannot be reliably deployed in engineering design, medical diagnosis and treatment planning, autonomous vehicle control, aerospace systems, or other safety-critical domains where outputs must provably satisfy physical constraints and regulatory requirements. The inability to ground outputs in physical reality creates unacceptable risks when AI-generated solutions could lead to structural failures, medical errors, or safety incidents.

AI cannot effectively contribute to scientific research because it lacks the ability to formulate hypotheses consistent with natural laws, design experiments accounting for physical constraints, or validate theoretical predictions against mathematical models. Similarly, AI systems cannot reliably design physical products, structures, machines, or systems because they cannot verify that designs satisfy engineering constraints including structural stability, thermal limits, electrical safety, and manufacturing feasibility. The absence of physics-based reasoning prevents AI from serving as a reliable tool for innovation and discovery in scientific and engineering domains.

Current AI systems cannot ensure that their recommendations comply with regulations, standards, and codes that are based on physical limits, safety margins, environmental constraints, or mathematical criteria for system performance. They cannot optimize resource allocation in scenarios where constraints are governed by conservation laws, capacity limits, physical throughput constraints, or temporal dynamics described by differential equations. This limitation severely restricts the applicability of AI in regulated industries and resource-constrained environments where compliance and optimization are critical.

AI cannot effectively teach subjects requiring integration of intuitive understanding with rigorous mathematical or scientific reasoning, such as physics, engineering, quantitative finance, or computational sciences. Educational applications require systems that can both explain concepts intuitively and demonstrate rigorous analytical methods, a capability that current AI systems cannot provide. Furthermore, users cannot trust AI outputs in high-stakes applications without the ability to verify that solutions are grounded in physical reality and satisfy applicable constraints, not merely linguistically plausible.

The core problem underlying all these limitations is that LLMs have a “flat world” (a two-dimensional understanding confined to textual patterns) when what is needed is a multi-dimensional understanding spanning linguistic sophistication, physical principles, mathematical rigor, and causal reasoning, all orchestrated by an intelligent executive controller that learns when and how to employ each mode of reasoning. The present invention addresses this fundamental problem by providing language models with the “world map” they currently lack through integration with analytical world models under adaptive metacognitive control.

The fundamental technical problem addressed by the present invention is the inability of current AI systems to achieve AGI (during inference), or a sufficiently close approximation thereof, due to the lack of integration between experiential language-based reasoning and analytical world-model-based computation, combined with the absence of an intelligent executive controller that can dynamically orchestrate these complementary reasoning modes.

This background information is provided to reveal information believed by the applicant to be of possible relevance to the present invention. No admission is necessarily intended, nor should be construed that any of the preceding information constitutes prior art against the present invention.

### SUMMARY OF THE INVENTION

With the above in mind, embodiments of the present invention are directed to a system and associated methods for multi-level generative AI and large language models (LLM) for generative AI applications, that utilize the following techniques:

Derived Requests: An initial level of generative AI software program, or AI broker, evaluates the incoming client request (maybe a conversational query or through an API, such as OpenAI API) and identifies its specific AI “characteristics” that may make it suitable for one or other or both or multiple AI language models and checks its “derived requests” categories to see if the query suits one of the “derived requests” categories and/or it can or should create a new request.

Multiple h-LLMs: If the new request does is not assigned to one or more of the “derived requests) categories, it evaluates the request and selects one or more AI h-LLM model categories for its evaluation. An h-LLM is a family of models, such as GPT-4, that (in addition) have been trained according to a particular training set T1. A family of generative models, LLM1, trained with a data set T1, can be represented as h-LLM1, while a family of models, LLM2, trained with data set T2, can be represented as h-LLM12. Further, a family of models, LLM1, trained with a data set T3, can be represented as h-LLM35. The combination of models and their training sets (T1 could be a subset of T3, for example, or they can be different) may be used in our proposed invention and they are referred to as h-LLMs, throughout. A family of LLMs that operate at a lower arithmetic precision, on computer CPUs or graphical processing units (GPUs, such as Nvidia's H100), may also be called by a different identifier, e.g., h-LLM14, when trained with its corresponding data set.

Choosing h-LLMs with varying levels of accuracy: It further checks the workload of the AI h-LLM models in the one or more categories and its level of training and its accuracy-called its workload scores or its technical accuracy scores, or its business value metrics or a combination of these scores, and then assigns the request (or its derived form) to one or more of the AI h-LLM models within the selected AI h-LLM model categories.

Assigning weights to results: It then receives the results from the AI models in the AI h-LLM models categories and weights them to compute a result that could be returned to the requester program, or it could resend the request back to the AI h-LLM models/categories hierarchy till it reaches a certain level of service level assurance.

Use of Local Database: It also updates a local database with the results of the request's path through its hierarchy and create an index of “derived requests” that may be used in future to select which set of “derived requests” an incoming request may fall into for further processing.

Distributed Architecture: The tasks may be implemented as containers within Kubernetes environment and a service mesh, such as Istio, may be used to instrument and parameterize the metrics and log collections, but not limited to these cloud models for implementation.

Additional embodiments of the present invention are directed to systems and associated methods for implementing artificial general intelligence through integration of experiential language-based reasoning with analytical world-model-based computation under intelligent state machine control. The invention, designated as the “Brain Processing Unit (BPU) system” or “World Model-Augmented AGI system”, particularly addresses the fundamental limitation of LLMs that, trained exclusively on text, possess only a two-dimensional “flat world” understanding confined to linguistic patterns without intrinsic knowledge of physical reality governed by mathematical laws and scientific principles.

The present invention addresses the technical limitations of existing LLM-based approaches through a novel hybrid cognitive architecture that augment LLMs with an analytical model that provides (during inference, for example) the “world map” they fundamentally lack. Computational models represent how physical, chemical, biological, and economic systems operate according to rigorous scientific principles rather than statistical correlations in text. This architecture enables dynamic orchestration between fast experiential processing leveraging pattern recognition and slow analytical processing employing physics-based simulation and mathematical computation, with an intelligent executive controller learning optimal routing strategies through reinforcement learning based on outcome feedback.

In one embodiment, the present invention comprises a Brain Processing Unit (BPU) system for inference during application of artificial general intelligence, the system comprising: a Language Processing Unit (LPU) configured to perform experiential reasoning based on transformer neural network architectures trained on text corpora; a World Processing Unit (WPU) configured to perform analytical reasoning based on physics simulators, mathematical model solvers, differential equation integrators, constraint solvers, and causal inference engines; a State Machine executive controller configured to analyze input characteristics and dynamically route computational tasks to the LPU, the WPU, or both operating in cooperation; an Integration and Validation Unit configured to merge outputs from the LPU and WPU, validate consistency, verify constraint satisfaction, and compute confidence scores during inference; and a Feedback Loop configured to update parameters of the State Machine, LPU, and WPU based on outcome feedback through reinforcement learning or supervised learning algorithms, as an option.

Another embodiment of the invention introduces a system-on-chip architecture for the Brain Processing Unit, the architecture comprising: a Central Executive Core implementing State Machine Controller hardware, Task Scheduler, Power Management Unit, and Clock Distribution; a plurality of Transformer Cores optimized for language model inference with Attention Engines and Token Cache; a plurality of Physics Compute Cores optimized for numerical simulation with Math Coprocessors and Differential Equation Solvers; a Unified Memory Subsystem with hierarchical caching including L1, L2, and L3 caches, DDR5 Memory Controller, and High Bandwidth Memory (HBM3) stack; a High-Speed Interconnect Fabric with Crossbar Switch, Network-on-Chip, and Cache Coherency Engine; specialized accelerators including Tensor Processing Units and Floating Point Units; and an On-Chip Learning Engine implementing Reward Calculator, Weight Update Unit, and Backpropagation Engine for continuous adaptation.

Another embodiment of the invention provides a method for artificial general intelligence through integrated experiential and analytical reasoning, the method comprising: receiving user input comprising queries, data, or commands; analyzing input characteristics including task type, complexity, urgency, risk level, domain, and constraints using a trained State Machine; routing the task to a Fast Path employing a Large Language Model for experiential reasoning, a Slow Path employing a World Model for analytical reasoning grounded in physical principles, or a Hybrid Path employing both models in cooperation based on the analysis; generating outputs using the selected processing pathway(s) wherein the Fast Path generates linguistically sophisticated responses through pattern matching and the Slow Path generates physically valid results through mathematical computation; merging outputs from multiple pathways using weighted combination, sequential refinement, or attention-based blending when both models are employed; validating merged outputs against physical constraints, regulatory requirements, and safety standards; computing confidence scores based on model agreement, constraint satisfaction margins, and historical accuracy; delivering final outputs to users with metadata specifying processing pathways employed and confidence metrics; and updating State Machine routing policies, LLM parameters, and World Model parameters based on outcome feedback through reinforcement learning.

Another embodiment of the invention comprises a World Processing Unit architecture serving as a “world model” that grounds language model understanding in physical reality, the architecture comprising: a Physics Simulator component implementing computational fluid dynamics, finite element analysis, thermodynamics, electromagnetism, and multi-physics simulations; a Mathematical Models component implementing algebraic models, differential equations, statistical models, and optimization frameworks; a Differential Equation Solver configured to numerically integrate ordinary and partial differential equations describing system dynamics; a Causal Inference Unit implementing directed acyclic graphs, structural causal models, do-calculus for interventional reasoning, and counterfactual analysis; a Constraint Solver implementing constraint satisfaction algorithms, linear programming, integer programming, and mixed-integer nonlinear programming; a Domain Knowledge Base storing scientific facts, engineering principles, regulatory standards, and industry-specific rules; a Time-Series Forecasting component, state space models, and neural forecasting methods; and an Optimization Engine implementing gradient-based methods, evolutionary algorithms, and multi-objective optimization for finding solutions satisfying physical constraints.

In another embodiment, the present invention comprises a method for implementing hybrid processing pathways that synergistically combine experiential and analytical reasoning, the method comprising: receiving tasks requiring both creative ideation and rigorous validation; routing to Hybrid Path engaging both LPU and WPU; operating in parallel processing mode wherein both models independently process inputs and generate separate outputs for subsequent merging; operating in sequential refinement mode wherein the LPU generates candidate solutions that are validated and refined by the WPU, or wherein the WPU computes feasible solution spaces that constrain LPU generation; operating in iterative collaboration mode wherein models alternate processing with each iteration refining outputs based on feedback from the other model; operating in constrained generation mode wherein the WPU defines physical constraint boundaries within which the LPU generates solutions; merging outputs using Result Blending Engine with learned or adaptive weights; checking consistency between linguistic descriptions from LPU and mathematical results from WPU; validating that merged outputs satisfy physical laws and regulatory requirements; and generating explanations documenting contributions from each model and rationale for integration strategy employed.

In another embodiment, the present invention implements a novel approach to overcoming the “flat world” limitation of text-only language models by providing a multi-dimensional physical reality representation, the approach comprising: identifying that LLMs trained exclusively on text lack understanding of physical laws, causal mechanisms, spatial relationships, temporal dynamics, and conservation principles; implementing a World Processing Unit as a complementary reasoning system that computes system behavior according to scientific principles including Newtonian mechanics, thermodynamics, electromagnetism, chemical kinetics, and biological processes; creating an Integration and Validation Unit that grounds LLM outputs in physical reality by validating linguistic descriptions against physics-based simulations; implementing consistency checking that detects when LLM-generated text violates physical principles or mathematical constraints; using the World Model to provide constraint boundaries, feasibility regions, and stability limits that guide LLM generation; enabling the LLM to generate creative, linguistically sophisticated solutions while the World Model ensures physical validity, mathematical correctness, and compliance with natural laws; and thereby providing language models with the “world map” of physical reality they fundamentally lack, transforming flat text understanding into multi-dimensional world understanding.

Another embodiment of the invention provides a State Machine executive controller implementing metacognitive control analogous to human executive function, the controller comprising: a Routing Logic component configured to map from input features to processing pathway decisions using decision trees, rule-based systems, or neural network classifiers; a Decision Engine implementing multi-criteria decision analysis considering trade-offs between response time, accuracy, computational cost, and energy consumption; a Mode Selector trained through reinforcement learning to choose between fast experiential processing, slow analytical processing, or hybrid processing based on historical performance data; a Merge Strategy Controller selecting integration approaches including weighted combination, sequential refinement, ensemble voting, or attention-based blending; a Context Analyzer extracting temporal, domain, user, and environmental context to inform routing decisions; a Risk/Urgency Evaluator assessing potential consequences of errors and time sensitivity to prioritize processing rigor versus speed; a Constraint Handler managing hard constraints that must never be violated and soft constraints to be optimized; and adaptive algorithms that learn from outcome feedback which processing strategies produce superior results for different task types, domains, and contexts.

Another embodiment comprises a domain-customizable BPU architecture wherein: multiple specialized World Processing Units are provided for different fields including engineering simulation, medical diagnosis, financial modeling, and scientific computation; the State Machine includes domain detection logic identifying subject matter of inputs; domain-specific routing policies and merge strategies are maintained for each field optimizing processing for domain characteristics; domain-specific knowledge bases store regulatory requirements, industry standards, and best practices; and the system supports enterprise customization through training custom world models on proprietary data, fine-tuning language models for company-specific terminology and workflows, and configuring validation rules enforcing organizational policies and compliance requirements.

Another embodiment of the invention implements explainable AI through processing transparency, the implementation comprising: logging State Machine routing decisions with rationale explaining why specific pathways were selected based on input characteristics; annotating processing pathways with metadata documenting which models contributed to outputs; generating natural language explanations of how LPU and WPU outputs were merged including weights or strategies employed; providing validation reports detailing which constraints were checked, which were satisfied, and margins of safety; documenting causal chains linking inputs to outputs through intermediate reasoning steps; identifying key assumptions and dependencies underlying outputs; presenting alternative solutions when multiple valid options exist with trade-off analyses; and providing provenance information including timestamps, model versions, and audit trails supporting regulatory compliance and accountability.

Another embodiment provides a distributed BPU architecture for scalable cloud deployment, the architecture comprising: distributing Language Processing Unit functionality across multiple computing nodes with load balancing; distributing World Processing Unit functionality across specialized nodes optimized for different simulation domains; implementing State Machine coordination through message-passing frameworks enabling distributed routing decisions; replicating critical components for fault tolerance enabling continued operation despite node failures; implementing data parallelism partitioning large datasets across nodes for parallel processing; implementing model parallelism partitioning large models across nodes when single-node memory is insufficient; providing elastic scaling dynamically allocating computational resources based on workload; and implementing secure multi-tenancy isolating processing for different users or organizations while sharing infrastructure.

### BRIEF DESCRIPTION OF THE DRAWINGS

FIG. 1 is an illustration of the training process for creating multiple specialized large language models for specific tasks/categories, according to an embodiment of the present invention.

FIG. 2 is an illustration of h-LLMs trained with different training sets, according to an embodiment of the invention.

FIG. 3 is an illustration of the process for generating synthetic data from multiple h-LLMs and using it for model refinement, according to an embodiment of the invention.

FIG. 4 is an illustration of a “bagging” approach where multiple h-LLMs with lower precision and accuracy are merged/fused to create a merged h-LLM with higher precision and accuracy, according to an embodiment of the invention.

FIG. 5 is an illustration of a “boosting” approach where multiple h-LLMs of increasing precision and accuracy are created in a sequential manner and then merged/fused to create a merged h-LLM, according to an embodiment of the invention.

FIG. 6 is an illustration of creating a smaller and more specialized h-LLM through extraction/specialization process from a larger h-LLM, according to an embodiment of the invention.

FIG. 7 is an illustration of combining h-LLMs trained with text, image and audio data to create a merged h-LLM, according to an embodiment of the invention.

FIG. 8 is an exemplary illustration of an application of using AI models for detecting labels in PDF files, according to an embodiment of the invention.

FIG. 9 is an illustration of generating derived prompts for different categories and using them with multiple h-LLMs to generate the best results, according to an embodiment of the present invention.

FIG. 10 is an illustration of using multiple h-LLMs to answer questions from specific input documents, according to an embodiment of the present invention.

FIG. 11 is an illustration of an AI Broker for processing results from multiple h-LLMs, according to an embodiment of the present invention.

FIG. 12 is an illustration of the combining h-LLMs in series, according to an embodiment of the present invention.

FIG. 13 is an illustration of combining h-LLMs in parallel, according to an embodiment of the present invention.

FIG. 14 is an illustration of a hybrid approach of combining h-LLMs in series and parallel, according to an embodiment of the present invention.

FIG. 15 is an illustration of the lambda architecture for h-LLMs, according to an embodiment of the present invention.

FIG. 16 is an illustration of batch and real-time processing architecture for h-LLMs, according to an embodiment of the present invention.

FIG. 17 is an illustration of an in-memory processing architecture for h-LLMs, according to an embodiment of the present invention.

FIG. 18 is an illustration of the architecture of PDF label search tool with CatchUp GlassViewer, according to an embodiment of the invention.

FIG. 19 is an exemplary interface of the CatchUp platform showing the document management system, according to an embodiment of the invention.

FIG. 20 is an exemplary interface of the CatchUp platform showing the PDF viewer (GlassViewer), according to an embodiment of the invention.

FIG. 21 is an exemplary interface of the CatchUp platform showing a magnifier tool within the GlassViewer for searching labels, according to an embodiment of the invention.

FIG. 22 is an exemplary interface of the CatchUp platform showing label search results within GlassViewer, according to an embodiment of the invention.

FIG. 23 is an illustration an architecture of an AI system, referred to as a Brain Processing Unit (BPU) system, according to an embodiment of the present invention.

FIG. 24 is an illustration of three parts of the BPU system of FIG. 23 with their internal components, according to an embodiment of the present invention.

FIG. 25 is a functional block diagram of the Brain Processing Unit (BPU) system, according to an embodiment of the present invention.

FIG. 26 is a flowchart illustrating a method of multiple collaboration modes between models along hybrid path, according to an embodiment of the present invention.

FIG. 27 is an illustration of operational modes of a merge and validate component, according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled people having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

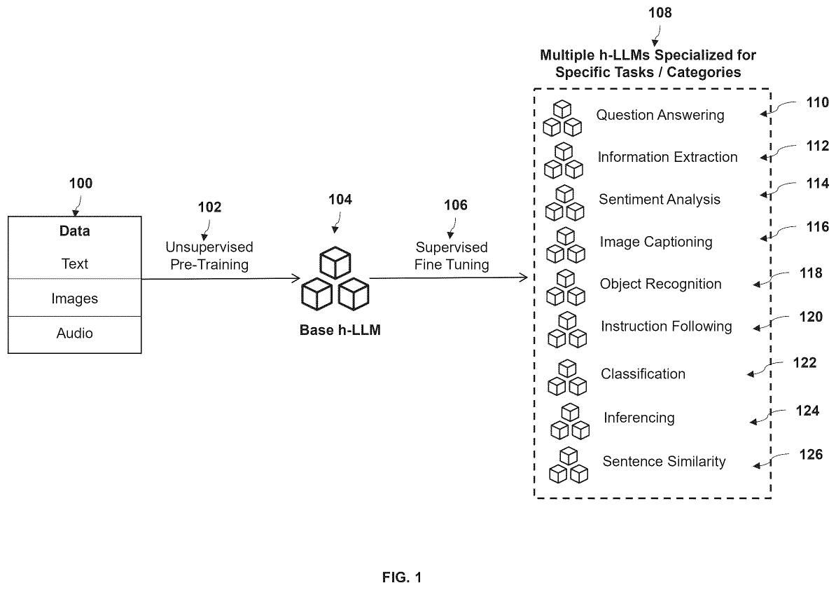

Referring now to FIG. 1 is an illustration of the training process for creating multiple specialized large language models for specific tasks/categories, is described in more detail. Data 100 (such as text, images, and audio) is used to pre-train a model in a process called unsupervised pre-training 102 which generates a base h-LLM model 104. The pre-training process is referred to as unsupervised as unlabeled data is used at this step. The base h-LLM model 104 is then fine-tuned in a process called supervised fine-tuning 106. The fine-tuning process uses smaller labeled data sets. The base h-LLM model 104 is fine-tuned to generate multiple h-LLM models which are specialized to perform specific tasks such as Question Answering, Information Extraction, Sentiment Analysis, Image Captioning, Object Recognition, Instruction Following, Classification, Inferencing, and Sentence Similarity, for instance.

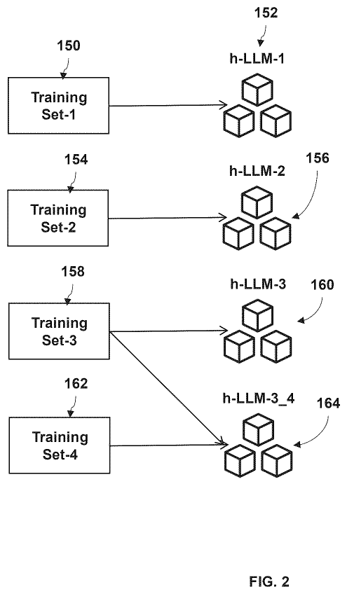

Referring now to FIG. 2 is an illustration of h-LLMs trained with different training sets, is described in more detail. As used in this specification h-LLM usually refers to a family of LLMs, such as those used in Google's Bard or OpenAI's GPT-4, that have been trained on a particular training set T. Therefore, the same family of LLMs (e.g., GPT) if trained on a different training set, T1, as opposed to GPT trained on training set T2 could be differentiated as a separate h-LLM). The training sets can be private within an organization or public datasets.

For example, as shown in FIG. 2, h-LLM-1 152 is trained with training set-1 150, h-LLM-2 156 is trained with training set-2 154, h-LLM-3 160 is trained with training set-3 158, and h-LLM-3_4 164 is trained with training set-3 158 and training set-4 162.

An h-LLM can be described as a combination of LLM families and the training dataset used as follows:

h-LLM=LLM family (X) trained with Training Set (Y)

For example,
h-LLM_1=PaLM-2 may be trained with training set T12
h-LLM_2=PaLM-2 may be trained with training set T12+T45
h-LLM_3=GPT-4 may be trained with Training Set T65
h-LLM_4=GPT-4 may be trained with ANY data set

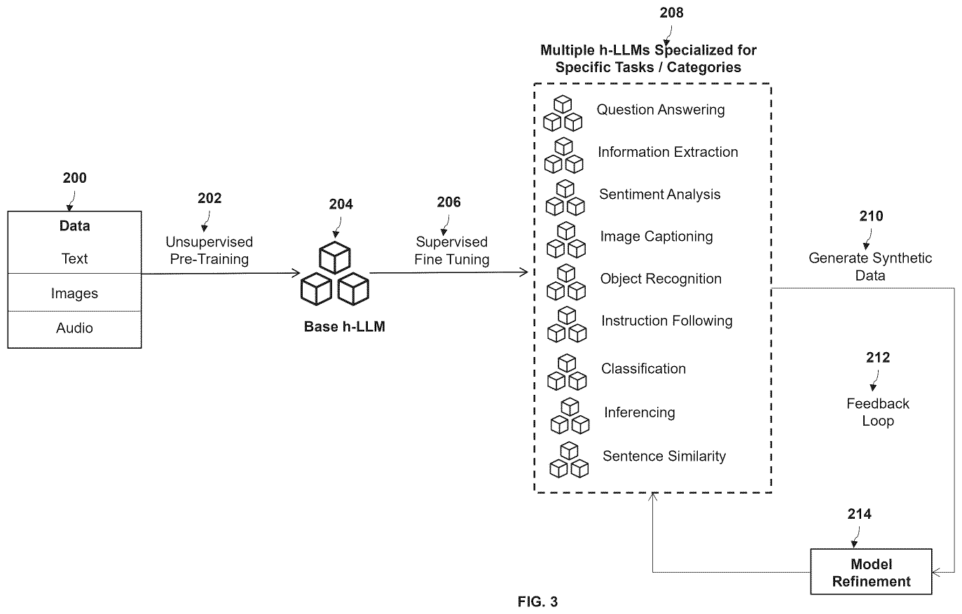

Referring now to FIG. 3, an illustration of the process for generating synthetic data from multiple h-LLMs and using it for model refinement, is described in more detail. Data 200 is used to train a base h-LLM model 204 using unsupervised pre-training 202 which is then fine-tuned in a supervised fine-tuning process 206 to generate multiple h-LLMs specialized for specific tasks or categories 208. Each of these h-LLMs 208 are used to generate synthetic data 210 which is then fed back to the models in feedback loop 212 through a process called model refinement 214.

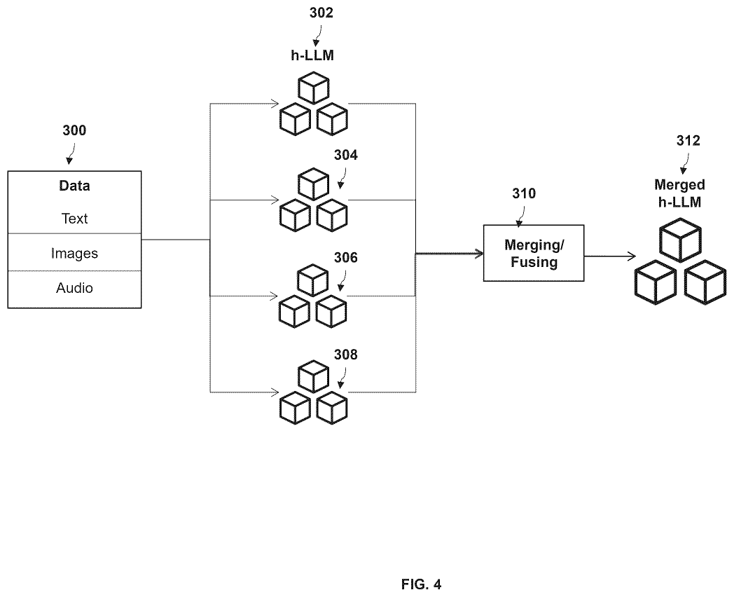

Referring now to FIG. 4 is an illustration of a bagging approach, that has some similarity to what was originally used in the context of machine learning models in a different way (for analytics as opposed to generative AI applications, such as LLMs) that are described in this invention, where multiple h-LLMs with lower precision and accuracy are merged/fused to create a merged h-LLM with higher precision and accuracy, is described in more detail. Bagging is a machine learning technique which improves the stability and accuracy of machine learning models. Using the input data 300, multiple subsets of the data are created which are used to train multiple h-LLMs (302, 304, 306, 308) in parallel. These models are then combined in a process called merging or fusing 310 to create a merged h-LLM 312.

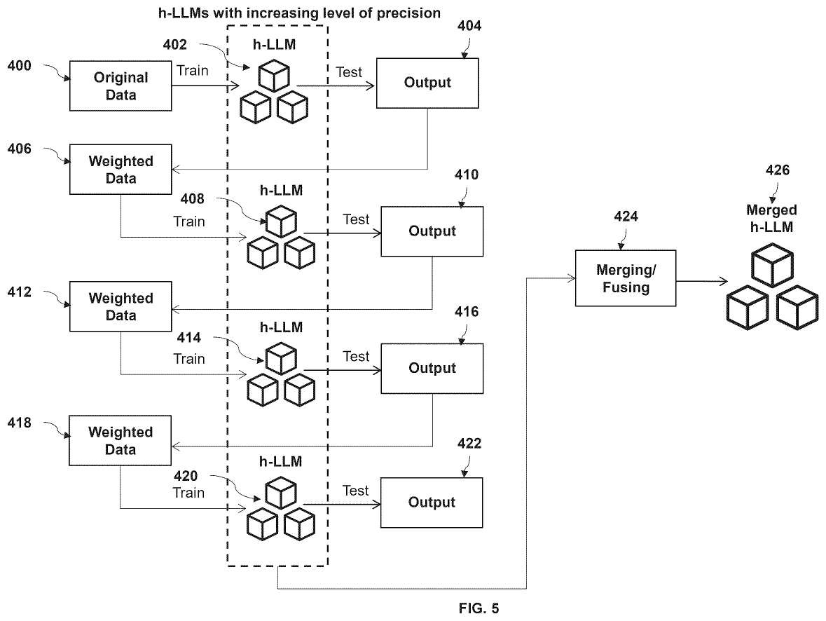

Referring now to FIG. 5 is an illustration a boosting approach, that has some similarities to that originally used in the context of machine learning models in a different way (for analytics as opposed to generative AI applications used in this invention) where multiple h-LLMs of increasing precision and accuracy are created in a sequential manner and then merged/fused to create a merged h-LLM, is described in more detail. Boosting is a machine learning technique that involves creating a stronger and more accurate model from a number of weaker models. The original data 400 is used to train an h-LLM 402. The h-LLM 402 is tested and the output 404 is assigned weights to generate weighted data 406. The weighted data 406 is then used to train h-LLM 408. The same process is then repeated and h-LLMs 414 and 420 are generated in a sequence. The h-LLMs 402, 408, 414 and 420 are then combined in a process called merging or fusing 424 to create a merged h-LLM 426.

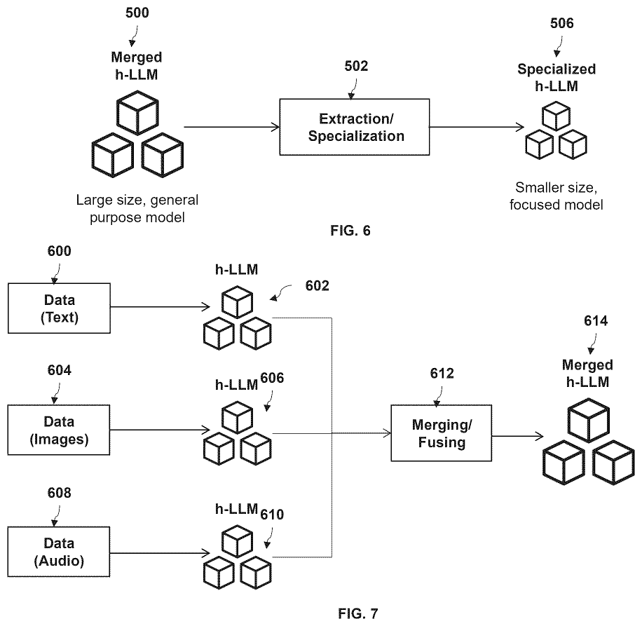

Referring now to FIG. 6 is an illustration of creating a smaller and more specialized h-LLM through extraction/specialization process from a larger h-LLM, is described in more detail. The extraction/specialization process 502 extracts the specific knowledge required for a task from a big, general-purpose model, and creates a smaller h-LLM 506. For example, a specific task can be sentiment analysis of input text, for which a smaller model 506 is more efficient as compared to a large, general-purpose model.

Referring now to FIG. 7 is an illustration of combining h-LLMs trained with text, image and audio data to create a merged h-LLM, is described in more detail. Text data 600 is used to train h-LLM 602, image data 604 is used to train h-LLM 606 and audio data 608 is used to train h-LLM 610. The h-LLMs 602, 604, 608 are combined in a process called merging/fusing to create a merged h-LLM 614.

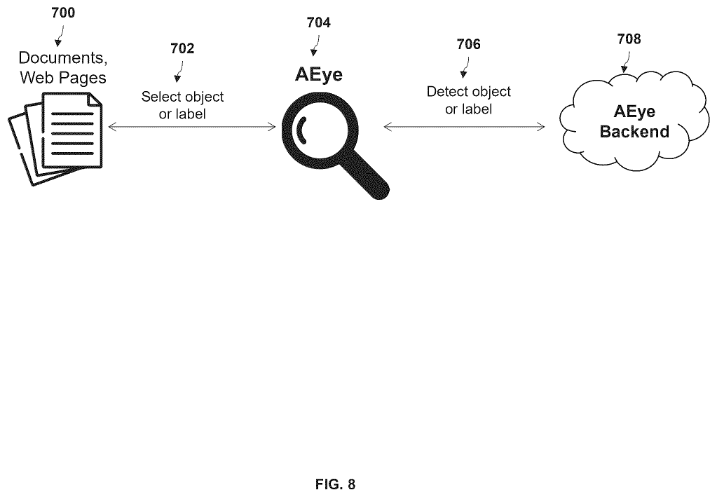

Referring now to FIG. 8 is an exemplary illustration of an application of using AI models for detecting labels in PDF files, is described in more detail. Patent documents (such as PDF files) have figures in which various entities/blocks/items are labeled using numeric labels (for instance 110, 120 and so on). These labels are referenced and described in the patent text specification. When reviewing multiple documents, readers find it difficult to quickly lookup the labels mentioned in the figures (and what they refer to) from the text, as they need to go back and forth between a figure and the text in the specification. A novel PDF Label search solution is offered within CatchUp which allows quick lookup of labels in a figure using an innovative “AI Magnifier” approach. The user can select one or more labels using the Magnifier tool in the CatchUp GlassViewer (a PDF viewer tool within CatchUp that has annotation and other AI features). When one or more labels are selected using the Magnifier tool, the labels are searched within the PDF and the search results are returned. The PDF Label Search tool is built upon a novel AI Magnifier technology (which we refer to as AEye). AEye serves as a gateway to the world of Artificial Intelligence (AI) for documents and web pages. AEye can be used for a wide range of applications such as detecting objects in images, labels in documents, for instance. Documents or web pages 700 can be searched using an AEye application 704 which detects objects or labels utilizing an AEye backend 708.

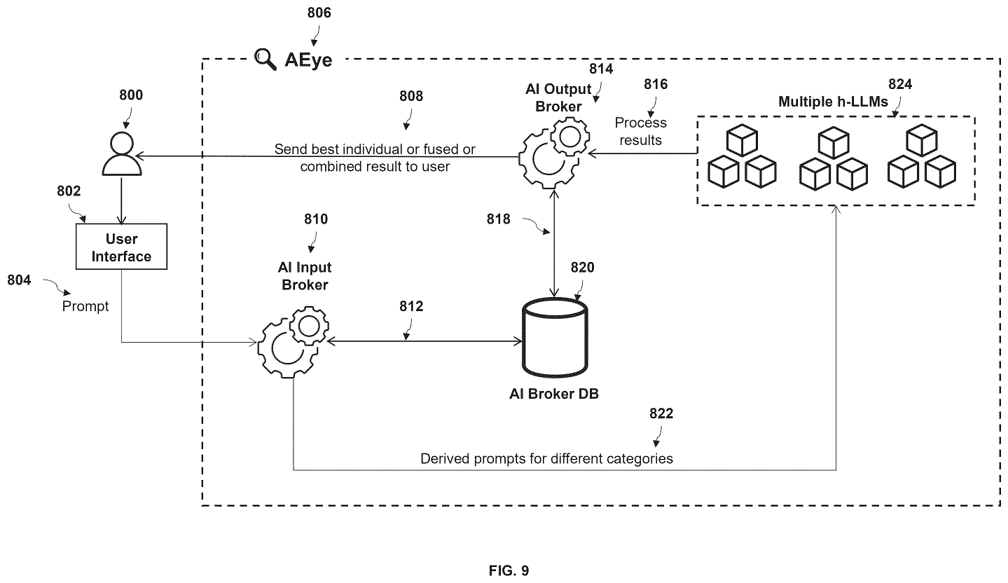

Referring now to FIG. 9 is an illustration of generating derived prompts for different categories and using them with multiple h-LLMs to generate the best results, is described in more detail. User 800 enters a prompt in user interface 802. The prompt is sent to the AI Input Broker 810 which generates multiple derived prompts for different categories. The derived prompts 822 are sent multiple h-LLMs 824 which produce the results. The results 816 are sent to the AI Output Broker 814 which processes the results and performs tasks such as filtering, ranking, weighting, assigning priorities, and then sends the best results to the user 800. The h-LLMs 824 can have varying levels of accuracy, and optimized for different tasks such as Question Answering, Information Extraction, Sentiment Analysis, Image Captioning, Object Recognition, Instruction Following, Classification, Inferencing, and Sentence Similarity, for instance. The AI Output Broker 814 computes various scores and assigns weights for ranking the results. The results may be sent back to the h-LLMs till a certain level of accuracy or service level assurance is reached. The AI Input Broker 810 and Output Broker 814 update a local AI Broker Database 820 with the results of the request's path through its hierarchy and create an index of “derived requests” that may be used in future to select which set of “derived requests” an incoming request may fall into for further processing.

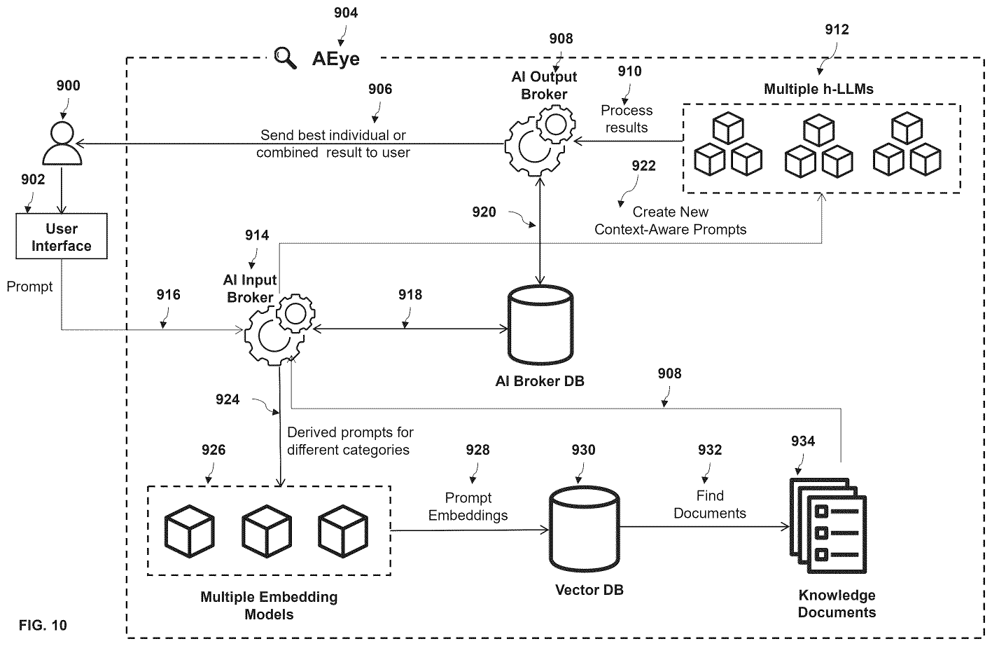

Referring now to FIG. 10 is an illustration of using multiple h-LLMs to answer questions from specific input documents, is described in more detail. User 900 enters a prompt in user interface 902. The prompt is sent to AI Input Broker 810 which generates multiple derived prompts for different categories 924. The prompts are converted into embeddings using multiple embedding models 926. The prompt embeddings 928 are sent to a vector database 930 which returns a list of knowledge documents 934 that are relevant to the prompt based on the similarity of their embeddings to the user's prompt. The knowledge documents 934 are sent to the AI Input Broker 810 which creates new context-aware prompts based on the user's initial prompt 916, derived prompts 924 and the retrieved knowledge documents 934 as context and sends it to multiple h-LLMs 912.

The results produced by multiple h-LLMs are processed by the AI Output Broker 908 and the best result is sent to the user 900 along with citations from the knowledge documents 934.

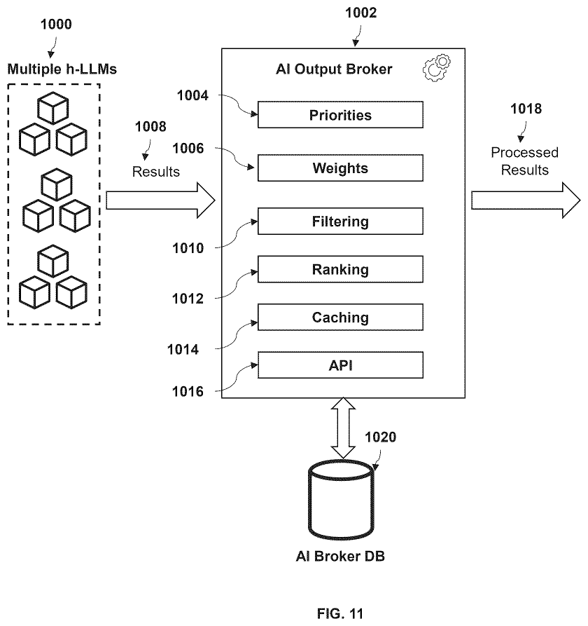

Referring now to FIG. 11 is an illustration of an AI Broker for processing results from multiple h-LLMs, is described in more detail. Results produced by multiple h-LLMs 1000 are sent to an AI Output Broker 1002 which performs tasks such as assigning priorities 1004 and weights 1006 to the results, filtering 1010, ranking 1012 and caching 1014. The AI Output Broker 1002 provides an API interface 1016 for configuring and managing various aspects of the broker. An AI Broker Database 1020 stores the results along with the meta-data information such as the request path. AI Broker Database 1020 creates an index of “derived requests” that may be used in future to select which set of “derived requests” an incoming request may fall into for further processing.

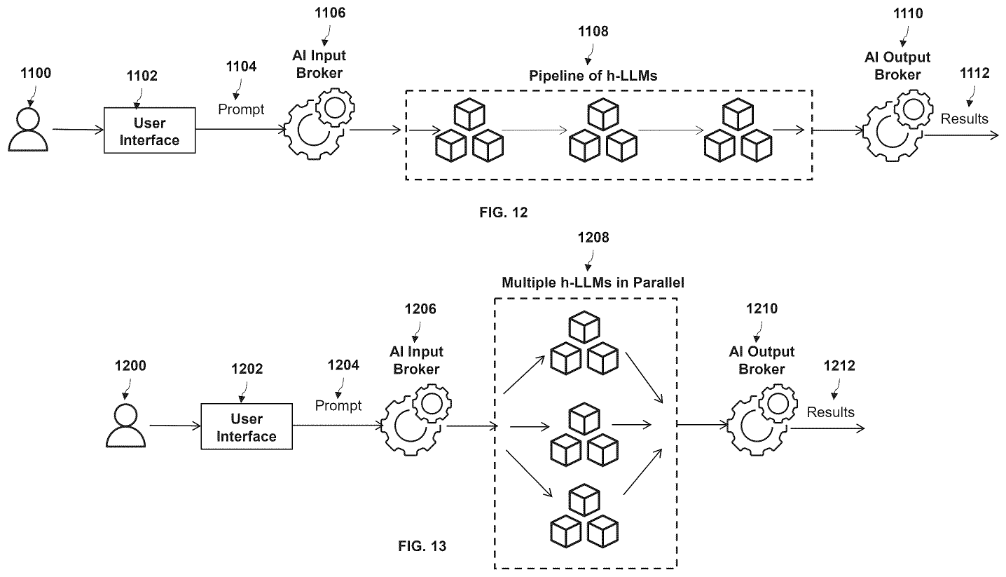

Referring now to FIG. 12 is an illustration of the combining h-LLMs in series, is described in more detail. User 1100 enters a prompt in user interface 1102. The prompt 1104 is sent to an AI Input Broker 1106 which generates a derived prompt by adding more contextual information. The derived prompt is sent to multiple h-LLMs 1108 connected in series. The derived prompt goes to the first h-LLM in the sequence which generates results. The results of the first h-LLM are sent to the second h-LLM in the sequence for refinement/enhancement and then to the third h-LLM and so on. The AI Output Broker 1110 processes the results 1112 and sends the processed results to user 1200.

Referring now to FIG. 13 is an illustration of combining h-LLMs in parallel, is described in more detail. User 1200 enters a prompt in user interface 1202. The prompt 1204 is sent to an AI Input Broker 1206 which generates multiple derived prompts by adding more contextual information. The derived prompts are sent to multiple h-LLMs 1208 which process the prompt in parallel generating multiple results. The AI Output Broker 1210 processes the results and sends the processed results 1212 to the user 1200.

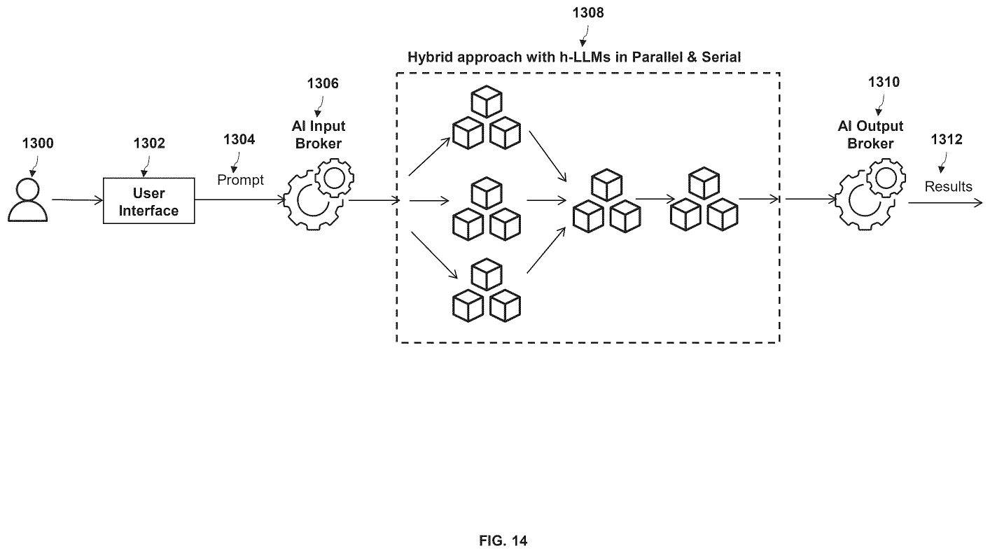

Referring now to FIG. 14 is an illustration of a hybrid approach of combining h-LLM in series and parallel, is described in more detail. User 1300 enters a prompt in user interface 1302. The prompt 1304 is sent to an AI Input Broker 1306 which generates multiple derived prompts by adding more contextual information. The derived prompts are sent to multiple h-LLMs 1308 which processes the prompts generating one or more results. The AI Output Broker 1310 processes the results and sends the processed results 1312 to the user 1300.

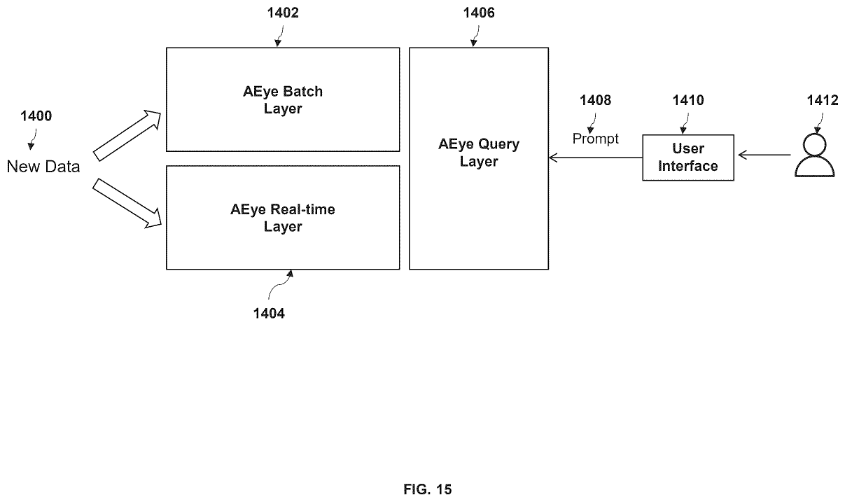

Referring now to FIG. 15 is an illustration of the lambda architecture for h-LLMs, is described in more detail. Lambda architecture is a way of processing massive quantities of data that provides access to batch-processing and stream-processing methods with a hybrid approach, often utilizing in-memory storage instead of disks for speedier processing. Such in-memory processing may be accomplished using a volatile memory device such as random-access memory (RAM) devices, static random-access memory (SRAM) devices, dynamics random-access memory (DRAM) devices, magnetoresistive random-access memory (MRAM) devices, and the like, or a non-volatile random-access memory (NVRAM) device. Such processing may be done partially or entirely in-memory.

This figure illustrates a lambda architecture for h-LLMs comprising batch layer 1402, real-time layer 1404 and a query layer 1406. New input data 1400 comes in continuously and is fed to the batch layer 1402 and real-time layer 1404 simultaneously. The batch layer 1402 maintains one or more h-LLMs which are updated/fine-tuned with the new data on a fixed schedule. Data is aggregated from the new input data 1400 over an aggregation duration that is tied to the fixed schedule. The real-time layer 1404 deals only with recent data which is not processed in the batch layer. The real-time layer 1404 maintains and updates smaller h-LLMs with incremental updates. The real-time layer 1404, also utilizes Map Reduce type analytics and computing and processing (See for example, tutorialspoint.com/map_reduce/map_reduce_introduction.htm) of tokens in the tokenization processes to improve speeds by which tokens are merged or otherwise aggregated in a distributed GPU computing environment, User 1412 sends a prompt 1408 through user interface 1410 to the query layer 1406. The query layer 1406 forwards the original prompt or creates one or more derived prompts which are sent to the batch and real-time layers. The query layer receives the results from the batch and real-time layers and performs tasks such as combining, ranking, filtering, assigning weights and priorities to the results and sends the best results to the user.

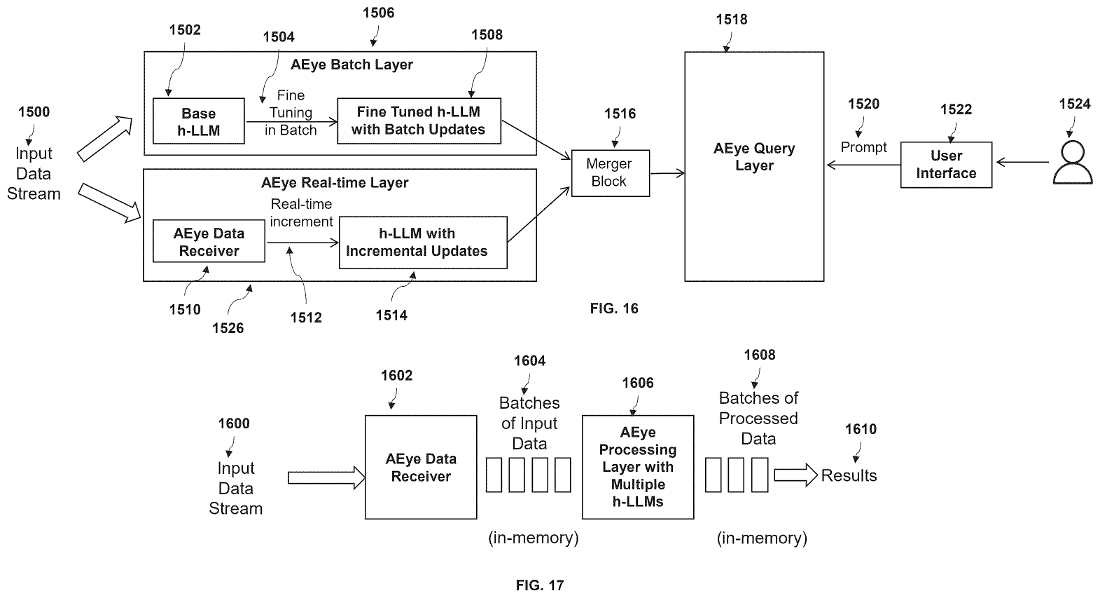

Referring now to FIG. 16 is an illustration of batch and real-time processing architecture for h-LLMs, is described in more detail. The input data stream 1500 is sent to batch layer 1506 and real-time layer 1526. The batch layer 1506 maintains a base h-LLM 1502 which is fine tuned 1504 in batch to generate fine-tuned h-LLM 1508. The real-time layer 1526 generates smaller h-LLMs with incremental updates 1514 in real-time increments 1512. The merger block 1516 combines and merges the h-LLMs from the batch layer and real-time layer to produce a combined h-LLM. The merged h-LLM is used with the query layer 1518 to respond to prompts 1520 sent by user 1524 through the user interface 1522.

Referring now to FIG. 17, an illustration of an in-memory processing architecture for h-LLMs, is described in more detail. The input data stream 1600 is sent to the data receiver 1602 which breaks the data into small batches 1604 which can be processed at least partially, and in some embodiments entirely, in-memory. The processing layer 1606 includes multiple h-LLMs which process the batches on input data and produce the batches of processed data 1608. Such batches may be produced after aggregating data from the input data stream 1600 over an aggregation duration.

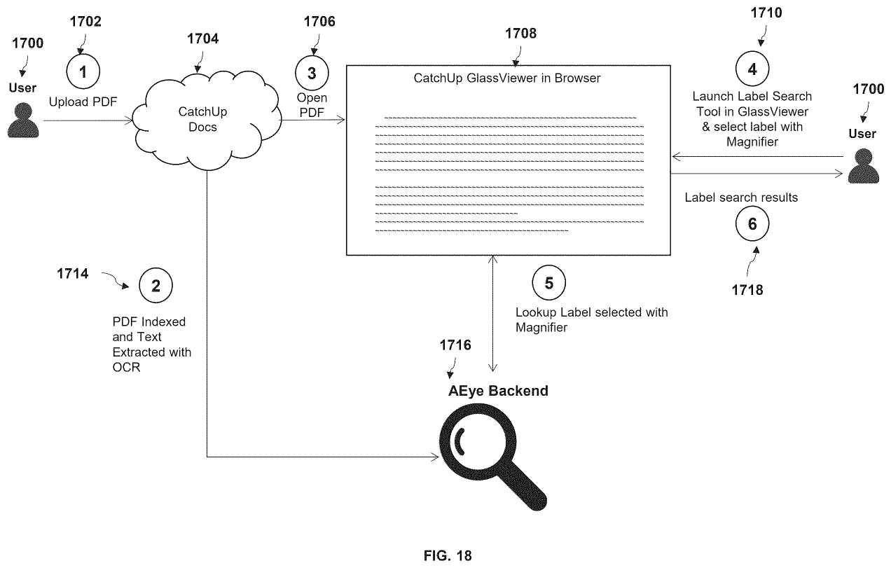

Referring now to FIG. 18 is an illustration of the architecture of PDF label search tool with CatchUp GlassViewer, is described in more detail. User 1700 uploads a PDF document 1702 to the CatchUp document management system 1704. The text of the PDF document is extracted and indexed 1714 in the AEye backend system 1716. Such extraction and indexing may be performed using character recognition analysis, including optical character recognition analysis. The user opens the PDF document 1706 with the CatchUp GlassViewer application 1708 in a browser. User 1700 launches the label search tool 1710 within the CatchUp GlassViewer application 1708 and selects a label using the magnifier tool. The selected label is sent to the AEye backend system 1716 which retrieves and returns 1718 all occurrences of the label.

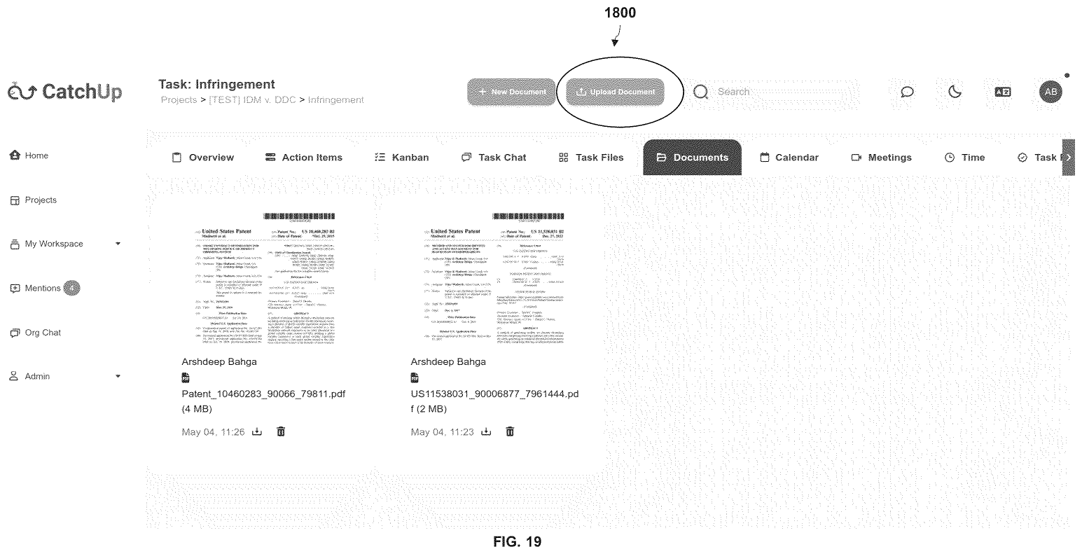

Referring now to FIG. 19 is an exemplary interface 1800 of the CatchUp platform showing the document management system, is described in more detail. Within this interface users can create new documents, upload existing documents, view and edit the documents.

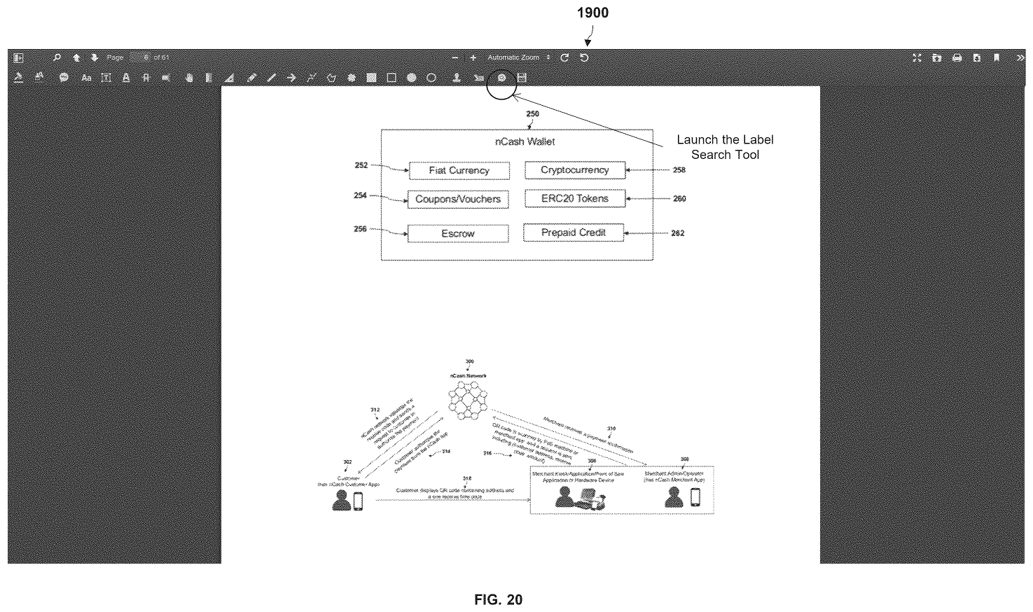

Referring now to FIG. 20 is an exemplary interface 1900 of the CatchUp platform showing the PDF viewer (GlassViewer), is described in more detail. GlassViewer is a PDF viewer application with CatchUp that allows annotating and commenting PDF files. The annotations and comments are stored in a separate layer which is rendered above the PDF document.

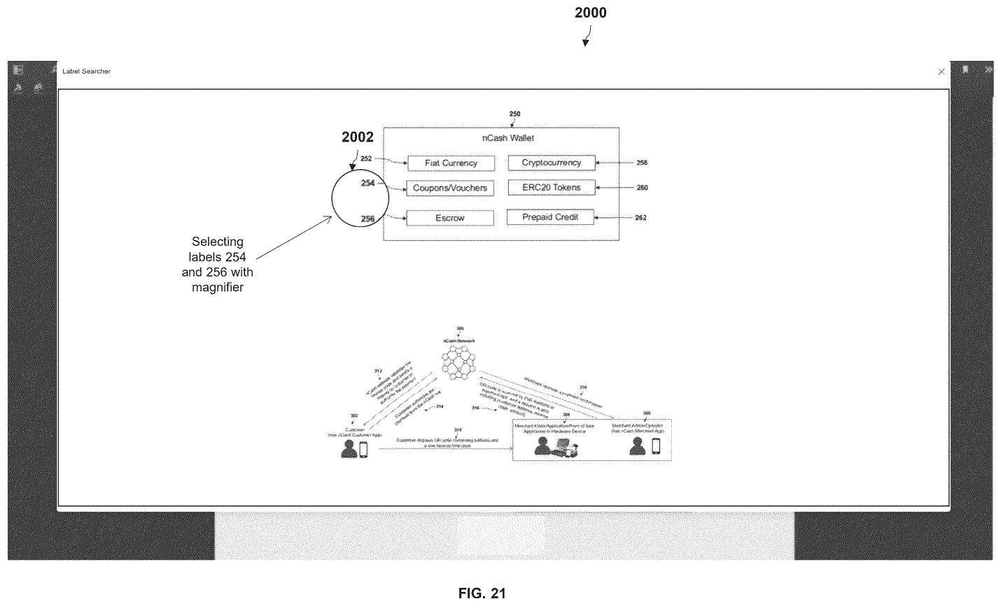

Referring now to FIG. 21 is an exemplary interface 2000 of the CatchUp platform showing a magnifier tool 2002 within the GlassViewer for searching labels, is described in more detail. GlassViewer includes a PDF label searching tool called AEye Label Searcher that allows quickly searching for all occurrences of selected labels within the PDF. AEye Label Searcher uses a magnifier to select specific labels within a region of the PDF which are sent to the AEye backend for processing, and the results are then displayed, which include excerpts from the document where the labels are mentioned. In some embodiments, the AEye backend may lookup labels within multiple documents or return additional information generated from one or more h-LLM models as taught elsewhere in other embodiments of this invention. For example, a legal brief may be first generated using a local (in-house) database of briefs and then supplemented by h-LLMs that are trained on public-domain training sets of legal briefs, and the combination may be merged as needed.

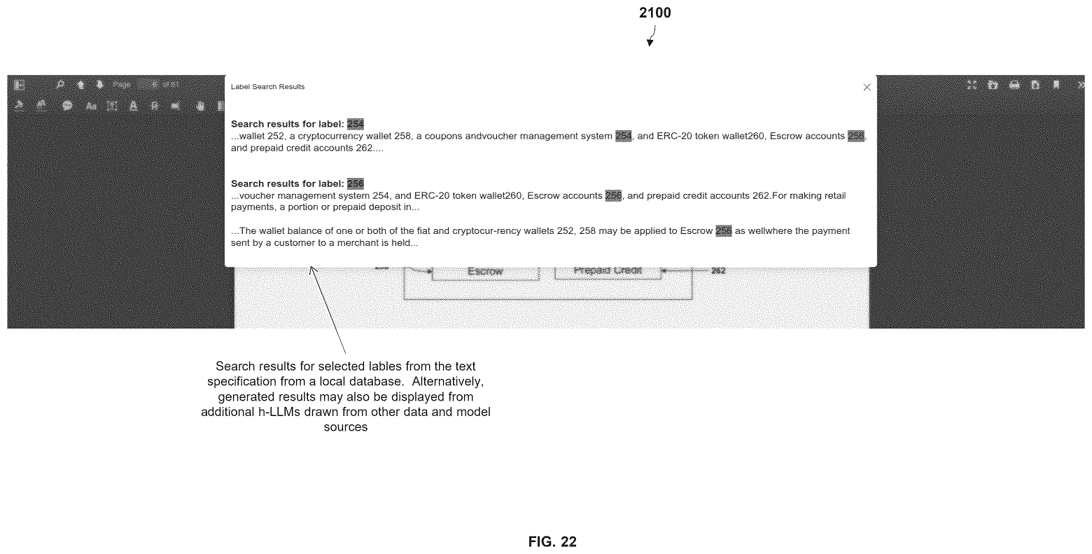

Referring now to FIG. 22 is an exemplary interface of the CatchUp platform showing label search results within GlassViewer, is described in more detail. The labels selected using the magnifier within the AEye Label Searcher are sent to the AEye backend for processing and the results are then displayed as shown in this figure.

Throughout the application, reference may be made to various computer hardware, including servers, GPUs, storage, cloud storage, and the like. It is contemplated and included within the scope of the invention that the CatchUp system and its various components may be software executed on computer devices, including servers, personal computers, smartphone devices, and the like, each comprising a processor configured to execute commands received from software (such as microprocessors, field-programmable gate arrays, integrated circuits, and the like), a non-transitory computer-readable storage medium positioned in electrical communication with the processor and operable to store software and other digital information thereupon in one or both of transitory and non-transitory status (such as hard disk drives, solid state drives, flash drives, compact flash drives, SD drives, memory, and the like), and a network communication device operable to communicate across computer networks as are known in the art, including, but not limited to, wide area networks such as the Internet and mobile data networks, local area networks such as Ethernet and Wi-Fi networks, and personal area networks such as Bluetooth networks. Accordingly, it is contemplated and included within the scope of the invention that the computer hardware performing the above-described CatchUp functions includes hardware necessary for such performance as is known in the art.

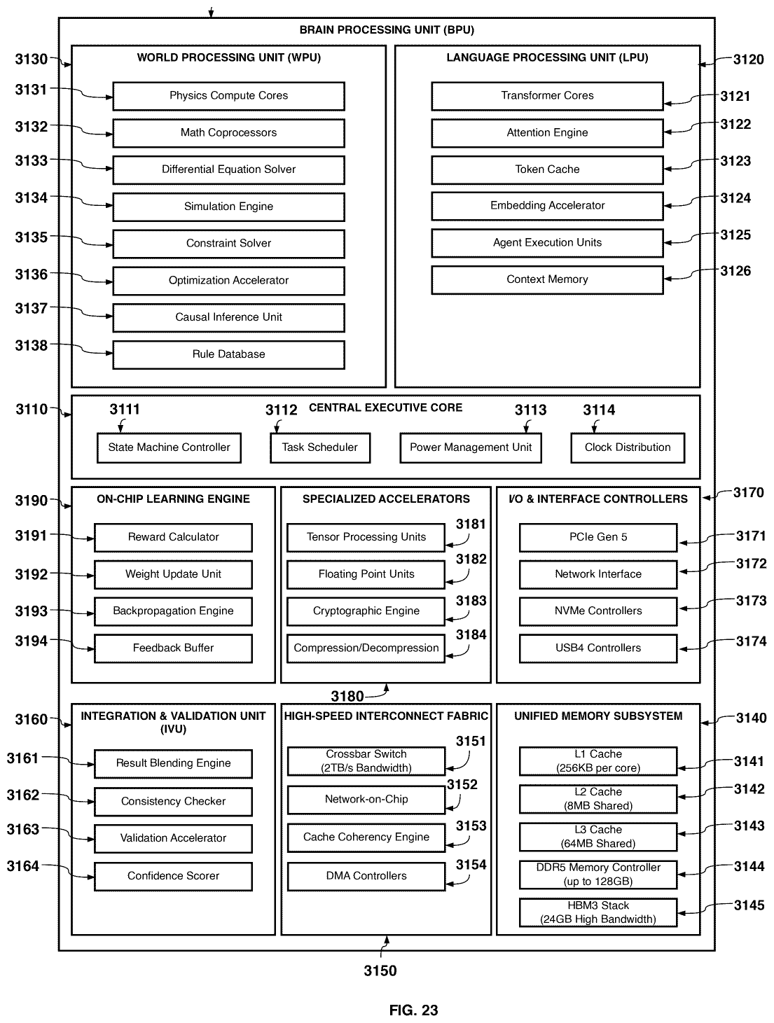

Referring now to FIG. 23, an illustration of an exemplary of architecture of a Brain Processing Unit (BPU), is described in more detail. The figure illustrates a system-on-chip (SoC) architecture for a Brain Processing Unit (BPU) 3100, which comprises a plurality of specialized processing subsystems, memory hierarchies, and interconnect fabrics configured to provide artificial general intelligence capabilities through the integration of experiential language-based reasoning with analytical world-model-based computation (during inference). It is contemplated and included within the scope of the invention that the BPU 3100 may be implemented in other modalities, for example, in a traditional computing architecture comprising a processor, a communication device, and a non-transitory computer-readable storage medium having software operable to perform the functions of the BPU 3100. The elements illustrated in FIG. 23 may be implemented in hardware, firmware, software, in software modules, in hardware/software combinations, or any other mode as is described and/or appropriate to the function described for the element.

The BPU 3100 includes a Central Executive Core 3110 comprising a State Machine Controller 3111, a Task Scheduler 3112, a Power Management Unit 3113, and a Clock Distribution network 3114. The State Machine Controller 3111 is configured to dynamically determine routing decisions between processing subsystems based on input characteristics, task complexity, urgency indicators, risk assessments, and constraint requirements. The State Machine Controller 3111 implements decision-making algorithms trained through reinforcement learning, supervised learning, or hybrid approaches to optimize processing strategy selection.

The Task Scheduler 3112 is configured to manage allocation of computational resources across the various processing units and coordinates parallel execution of tasks to maximize throughput while respecting dependencies and resource constraints. The Task Scheduler 3112 may implement one or more scheduling policies including priority-based scheduling, fair scheduling, deadline-aware scheduling, or energy-aware scheduling.

The Power Management Unit 3113 is configured to dynamically adjust power delivery to individual processing subsystems based on workload demands to optimize energy efficiency while meeting performance requirements. The Power Management Unit 3113 supports multiple power states including active processing, idle, sleep, and deep sleep states, and implements dynamic voltage and frequency scaling (DVFS) to balance performance and power consumption.

The Clock Distribution network 3114 is configured to provide synchronized timing signals to all components of the BPU 3100, implementing clock domain crossing mechanisms for components operating at different frequencies and ensuring timing closure across the integrated circuit.

The BPU 3100 further comprises a Language Processing Unit (LPU) 3120 configured for experiential reasoning and natural language processing. The LPU 3120 is optimized for rapid pattern-matching, linguistic understanding, creative generation, and intuitive reasoning based on learned statistical patterns from training corpora.

The LPU 3120 comprises a plurality of Transformer Cores 3121, where each core implements hardware-accelerated execution of transformer neural network operations including multi-head self-attention, feed-forward networks, layer normalization, and residual connections.

The LPU 3120 further comprises an Attention Engine 3122 configured to accelerate multi-head attention computations across token sequences, implementing optimized matrix multiplication engines, softmax computation units, and memory access patterns optimized for attention score calculation and weighted aggregation.

The LPU 3120 further comprises a Token Cache 3123, which provides high-speed storage for recently processed token embeddings to reduce redundant computation when processing similar or overlapping contexts. The Token Cache 3123 one or more implements cache replacement policies as are known in the art, such as, but not limited to, least-recently-used (LRU) or learned replacement policies that predict future access patterns.

The LPU 3120 further comprises an Embedding Accelerator 3124, which is configured to rapidly convert input tokens to high-dimensional vector representations by performing table lookups in learned embedding matrices. The Embedding Accelerator 3124 supports embeddings for multiple modalities including text tokens, image patches, audio frames, and structured data types.

The LPU 3120 further comprises a plurality of Agent Execution Units 3125, with each Agent Execution Unit 3125 being configured to execute one or more autonomous agent workflows including, but not limited to, multi-step planning, tool use, code execution, and goal-directed behavior. The Agent Execution Units 3125 implement secure sandboxed execution environments for, for example, running generated code, invoking external APIs, and performing computational tasks.

The LPU 3120 further comprises a Context Memory 3126 that is configured to store information relevant to the operation of the LPU 3120, including, but not limited to, conversational history, episodic memory, user preferences, and contextual information required for coherent multi-turn interactions. The Context Memory 3126 may be operable to implement one or more associative memory structures enabling efficient retrieval of relevant historical information based on similarity to current context.

The BPU 3100 further comprises a World Processing Unit (WPU) 3130 configured for analytical reasoning, physical simulation, and mathematical computation based on scientific principles and causal models. The WPU 3130 provides the “world model” that grounds the linguistic understanding of the LPU 3120 in physical reality.

The WPU 3130 comprises a plurality of Physics Compute Cores 3131, each Physics Compute Core 3131 being optimized for numerical simulation of physical systems including, but not limited to, computational fluid dynamics (CFD), finite element analysis (FEA), structural mechanics, thermodynamics, electromagnetism, quantum mechanics, and multi-physics coupled simulations. Any other physical systems as may be known in the art are contemplated and included within the scope of the invention. Each Physics Compute Core 3131 implements specialized arithmetic units for floating-point operations, vector operations, and matrix operations commonly required in physics simulations.

The WPU 3130 further comprises a plurality of Math Coprocessors 3132, each Math Coprocessor 3132 being configured for high-precision arithmetic operations, matrix computations, eigenvalue decomposition, singular value decomposition, and statistical calculations. The Math Coprocessors 3132 may implement specialized hardware for transcendental functions (exponential, logarithm, trigonometric), special functions (Bessel, gamma, error functions), and arbitrary-precision arithmetic, as well as any other function or operation that may require specialized hardware.

The WPU 3130 further comprises a Differential Equation Solver 3133, which is configured to numerically integrate systems of ordinary differential equations (ODEs) and partial differential equations (PDEs) describing temporal evolution of physical, chemical, biological, or economic systems. The Differential Equation Solver 3133 implements multiple integration methods including explicit methods (Runge-Kutta), implicit methods (backward differentiation formulas), and adaptive methods that automatically adjust timestep sizes based on local error estimates.

The WPU 3130 further comprises a Simulation Engine 3134 that is configured to execute domain-specific simulation models representing real-world systems and processes. The Simulation Engine 3134 supports a variety of simulation methods, including, but not limited to, discrete-event simulation, agent-based simulation, Monte Carlo simulation, and hybrid simulation frameworks combining continuous and discrete dynamics.

The WPU 3130 further comprises a Constraint Solver 3135 that is configured to determine solutions satisfying specified constraints, including, but not limited to, equality constraints, inequality constraints, boundary conditions, and logical constraints. The Constraint Solver 3135 implements one or more algorithms, such as constraint propagation, backtracking search, local search methods, and satisfiability modulo theories (SMT) solving.

The WPU 3130 further comprises an Optimization Accelerator 3136 that is configured to perform one or both of constrained and unconstrained optimization using methods including, but not limited to, gradient descent, conjugate gradient, Newton's method, quasi-Newton methods (BFGS), interior point methods, sequential quadratic programming, genetic algorithms, particle swarm optimization, simulated annealing, and mixed-integer linear and nonlinear programming.

The WPU 3130 further comprises a Causal Inference Unit 3137 that is configured to identify causal relationships from observational and experimental data using methods including but not limited to Bayesian networks, structural causal models, do-calculus for interventional reasoning, instrumental variable analysis, regression discontinuity designs, and counterfactual reasoning frameworks.

The WPU 3130 further comprises a Rule Database 3138 configured to store rules related to operation of the WPU 3130 that may include, but are not limited to, domain-specific rules, regulatory requirements, safety constraints, industry standards, best practices, and expert knowledge encoded in machine-readable formats including first-order logic, production rules, decision tables, and semantic networks.

The BPU 3100 further comprises a Unified Memory Subsystem 3140 configured to provide hierarchical storage accessible by all processing units comprised by the BPU 3100 through a high-speed interconnect fabric 3150. The unified memory architecture of the Unified Memory Subsystem 3140 enables efficient data sharing between the LPU 3120 and WPU 3130 without requiring explicit data copying operations.

The memory hierarchy of the Unified Memory Subsystem 3140 may comprise multiple cache levels optimized for different access patterns and latencies. An L1 Cache 3141 (e.g. with a capacity of 256 kilobytes (KB) per processing core) comprised by the Unified Memory Subsystem 3140 may provide lowest-latency access to frequently accessed data with typical access latencies of 1-4 clock cycles. The L1 Cache 3141 is typically implemented as separate instruction and data caches with high associativity.

An L2 Cache 3142 (e.g. with a shared capacity of 8 megabytes (MB)) comprised by the Unified Memory Subsystem 3140 may provide intermediate-latency storage accessible by groups of processing cores (typically 2-4 cores per L2 cache bank) with typical access latencies of 10-20 clock cycles. The L2 Cache 3142 is typically implemented as a unified cache storing both instructions and data with moderate to high associativity.

An L3 Cache 3143 (e.g. with a shared capacity of 64 MB) comprised by the Unified Memory Subsystem 3140 may provide higher-capacity storage accessible by all processing subsystems with access latencies of 30-50 clock cycles. The L3 Cache 3143 is typically implemented as a victim cache receiving evictions from L2 caches and as a shared resource for inter-core communication.

The Unified Memory Subsystem 3140 further comprises a DDR5 Memory Controller 3144 configured to interface with external Double Data Rate 5 (DDR5) synchronous dynamic random-access memory (SDRAM) modules (e.g. with a capacity of up to 128 gigabytes (GB)). The DDR5 Memory Controller 3144 supports multiple memory channels (e.g. 4-8 channels) to provide aggregate memory bandwidth (e.g. 200-400 GB/s). The controller implements features including error correction codes (ECC), memory scrubbing, rank interleaving, and adaptive refresh to maintain data integrity. It is further contemplated and included within the scope of the invention that memory controllers operable to interface with RAM modules of varying standards and performance are included and within the scope of the invention.

The Unified Memory Subsystem 3140 further comprises an HBM3 Stack 3145 comprising High Bandwidth Memory 3 (HBM3) (e.g. with a capacity of 24 GB). The HBM3 Stack 3145 provides ultra-high bandwidth memory access exceeding 1 terabyte per second (TB/s) through wide interfaces (e.g. 1024-2048 bits) operating at moderate frequencies. The HBM3 is beneficial for bandwidth-intensive operations such as, for example, large matrix multiplications required for language model inference and attention computations.

The BPU 3100 further comprises a High-Speed Interconnect Fabric 3150 configured to provide low-latency, high-bandwidth communication between all processing subsystems and memory hierarchies comprised by the BPU 3100. The Interconnect Fabric 3150 may implement a cache-coherent memory system enabling seamless data sharing between heterogeneous processing units.

The Interconnect Fabric 3150 comprises a Crossbar Switch 3151, which has an aggregate bandwidth (e.g. 2 TB/s), enabling simultaneous point-to-point communication between multiple subsystems comprised by the BPU 3100. The Crossbar Switch 3151 may implement non-blocking routing allowing N-to-N communication patterns, where N represents the number of connected endpoints. The Crossbar Switch 3151 supports quality-of-service (QOS) mechanisms including priority levels, bandwidth reservation, and latency guarantees for real-time processing requirements.

The Interconnect Fabric 3150 further comprises a Network-on-Chip (NoC) 3152 configured to provide packet-switched communication infrastructure with deadlock-free routing algorithms. The NoC 3152 may implement at least one of a mesh, torus, or hierarchical topology, or any other topology optimized for the physical layout of processing subsystems of the BPU 3100.

The Interconnect Fabric 3150 further comprises a Cache Coherency Engine 3153 that is configured to maintain consistency across the distributed cache hierarchy. Maintaining consistency may be accomplished by using one or more coherence protocols, such as, but not limited to, MESI (Modified, Exclusive, Shared, Invalid), MOESI (Modified, Owner, Exclusive, Shared, Invalid), or directory-based coherence protocols. The Cache Coherency Engine 3153 may be functional to ensure that when one processing unit modifies data in its cache, all other cached copies are either invalidated or updated, maintaining a consistent view of memory across all processing subsystems.

The Interconnect Fabric 3150 further comprises a plurality of Direct Memory Access (DMA) Controllers 3154, being configured to perform memory-to-memory transfers, memory-to-peripheral transfers, and/or peripheral-to-memory transfers without processor intervention. The DMA Controllers 3154 may be configured to support scatter-gather operations, linked-list descriptors for chained transfers, and interrupt generation upon transfer completion. Each DMA Controller 3154 may implement multiple channels enabling concurrent transfers.

The BPU 3100 further comprises an Integration and Validation Unit (IVU) 3160 that is configured to merge, validate, and reconcile outputs from the Language Processing Unit 3120 and the World Processing Unit 3130. The IVU 3160 may ensure that final outputs produced by the BPU 3100 combine the linguistic sophistication of the LPU 3120 with the physical validity guaranteed by the WPU 3130.

The IVU 3160 comprises a Result Blending Engine 3161 that is configured to combine outputs from multiple processing subsystems using various integration strategies. The Result Blending Engine 3161 may implement one or more combining methods including, but not limited to, weighted averaging with learned or adaptive weights, ensemble combination using voting or stacking, sequential refinement where one model's output guides another model's processing, and attention-based blending that dynamically weights contributions based on confidence scores and relevance metrics.

The IVU 3160 further comprises a Consistency Checker 3162 that is configured to identify contradictions or inconsistencies between outputs generated by different processing subsystems. The Consistency Checker 3162 may implement logical consistency checking to detect one or more of statements that contradict each other, numerical consistency checking to verify that quantitative predictions from different models agree within tolerances, and semantic consistency checking to ensure that linguistically expressed concepts align with mathematical or physical models.

The IVU 3160 further comprises a Validation Accelerator 3163 that is configured to verify that generated outputs satisfy specified constraints including physical laws, regulatory requirements, safety margins, and business rules. The Validation Accelerator 3163 may implement one or more constraint checking engines that are operable evaluate outputs against rule databases, perform physics-based validations that verify compliance with conservation laws and physical limits, perform regulatory validations that check adherence to industry standards and legal requirements, and perform safety validations that ensure outputs remain within safe operating regions.

The IVU 3160 further comprises a Confidence Scorer 3164 that is configured to compute confidence metrics for outputs based on multiple factors. The Confidence Scorer 3164 may implement one or more algorithms that consider model agreement (higher confidence when LPU and WPU produce similar outputs), constraint satisfaction margins (higher confidence when outputs satisfy constraints with comfortable margins), historical accuracy (higher confidence for task types where the system has performed well historically), uncertainty quantification from probabilistic models, and ensemble diversity metrics.

The BPU 3100 further comprises I/O and Interface Controllers 3170 that are configured to provide connectivity to external devices, networks, storage systems, and peripheral components. The I/O and Interface Controllers 3170 enable the BPU 3100 to function as part of larger computing systems and to interact with the physical world through sensors and actuators.

The I/O and Interface Controllers 3170 may comprise a PCIe Gen 5 interface 3171 (e.g. with sixteen lanes (×16)), providing bidirectional bandwidth (e.g. approximately 64 GB/s per direction). The PCIe interface 3171 enables high-bandwidth communication with external accelerators (such as GPUs, FPGAs, ASICs), high-performance storage devices (such as NVMe SSDs), network interface cards, and other PCIe-compatible peripheral components. It is contemplated and included within the scope of the invention that the I/O and Interface Controllers 3170 may comprise an interface according to any standard and/or standard generation to enable communication with peripheral components as described herein.

The I/O and Interface Controllers 3170 further comprises a Network Interface 3172 (e.g. an interface device supporting 400 Gigabit Ethernet (400 GbE)) that is configured to enable high-speed network communication for distributed computing scenarios, cloud deployments, and data center integration. The Network Interface 3172 may implement one or more of hardware offload protocols including, but not limited to, TCP/IP protocol processing, RDMA (Remote Direct Memory Access) for low-latency communication bypassing the operating system, encryption/decryption for secure communications, and packet filtering and classification.

The I/O and Interface Controllers 3170 further comprises a plurality of NVMe Controllers 3173 (e.g. 4-8), configured to interface with Non-Volatile Memory Express (NVMe) solid-state storage devices. Each NVMe Controller 3173 supports multiple namespaces, implements command queuing with thousands of outstanding commands for high parallelism, and provides direct memory access to storage devices. The NVMe Controllers 3173 support NVMe features including end-to-end data protection, namespace management, and firmware updates. It is further contemplated and included within the scope of the invention that other non-volatile memory controllers compliant with other standards may be comprised by the I/O and Interface Controllers 3170.

The I/O and Interface Controllers 3170 further comprises a plurality of USB4 Controllers 3174 (e.g. 4-8), providing connectivity to Universal Serial Bus 4 (USB4) devices with high bandwidth (e.g. up to 40 Gb/s per port). The USB4 Controllers 3174 support multiple protocols including USB 3.2, DisplayPort, and PCIe tunneling, enabling connection to diverse peripheral devices including displays, input devices, storage devices, and sensors. Controllers configured to support other serial peripheral devices as are known in the art are contemplated and included within the scope of the invention.

The BPU 3100 further comprises a plurality of Specialized Accelerators 3180 optimized for specific computational workloads that occur frequently in AI processing. The Specialized Accelerators 3180 provide higher performance and energy efficiency compared to general-purpose processing cores for their targeted operations.

The Specialized Accelerators 3180 comprise a plurality of Tensor Processing Units 3181 (e.g. 4-8), which may be optimized for matrix multiplication and convolution operations used extensively in deep learning inference and training. Each Tensor Processing Unit 3181 may implement one or more systolic array architectures with hundreds to thousands of multiply-accumulate (MAC) units arranged in two-dimensional grids, providing peak performance of tens to hundreds of TOPS (tera-operations per second) for INT8 or BF16 data types.

The Specialized Accelerators 3180 further comprises a plurality of Floating Point Units 3182 (e.g. 8-16), which may be configured to provide high-throughput execution of floating-point arithmetic operations compliant with IEEE 754 or any other applicable standards. The Floating Point Units 3182 may support multiple precision formats including single-precision (FP32), double-precision (FP64), half-precision (FP16), and bfloat16 (BF16). The Floating Point Units 3182 may implement fused multiply-add (FMA) operations that perform multiplication and addition in a single operation with a single rounding step, improving both performance and numerical accuracy.

The Specialized Accelerators 3180 further comprises a Cryptographic Engine 3183 that is configured to perform encryption, decryption, hashing, digital signature generation and verification, and key derivation operations using hardware acceleration. The Cryptographic Engine 3183 may implement one or more algorithms including, but not limited to, symmetric encryption (such as AES-128, AES-256, ChaCha20), asymmetric encryption (such as RSA-2048, RSA-4096), elliptic curve cryptography (such as ECDSA, ECDH using NIST curves and Curve25519), and hashing (such as SHA-256, SHA-512, SHA-3). The Cryptographic Engine 3183 may support cryptographic operations at multi-gigabit per second throughput to enable secure communications without performance bottlenecks.

The Specialized Accelerators 3180 further comprises a Compression/Decompression unit 3184 that is configured to perform hardware-accelerated data compression and decompression using algorithms (such as LZ4, ZSTD, DEFLATE, Brotli). The Compression/Decompression unit 3184 may be operable to provide throughput of multiple gigabytes per second, enabling efficient storage utilization and network bandwidth reduction. The Compression/Decompression unit 3184 may support configurable compression levels trading compression ratio against processing throughput.

The BPU 3100 further comprises an On-Chip Learning Engine 3190 configured to perform real-time learning and adaptation based on outcome feedback, enabling the system to continuously improve performance during deployment. The On-Chip Learning Engine 3190 may implement the feedback loop to enable the BPU 3100 to learn improved processing strategies through continued operation and experience.

The On-Chip Learning Engine 3190 comprises a Reward Calculator 3191 that is configured to compute reward signals based on multiple criteria including one or more of, but not being limited to, task completion success, constraint satisfaction (e.g. did outputs satisfy all required constraints), user feedback (e.g. explicit ratings or implicit signals like acceptance/rejection of outputs), execution efficiency (e.g. processing time, energy consumption, resource utilization), and performance metrics (e.g. accuracy, precision, recall, F1 score for classification tasks).

The On-Chip Learning Engine 3190 further comprises a Weight Update Unit 3192 that is configured to adjust neural network weights, state machine parameters, routing policies, and merge strategy parameters based on computed rewards using one or more optimization algorithms, such as, but not limited to, stochastic gradient descent, momentum-based methods, adaptive learning rate methods, and reinforcement learning methods.

The On-Chip Learning Engine 3190 further comprises a Backpropagation Engine 3193 that is configured to compute gradients of loss functions with respect to model parameters using reverse-mode automatic differentiation. The Backpropagation Engine 3193 may implement one or more of efficient computation graphs, memory optimization through gradient checkpointing, and mixed-precision training using lower precision for forward and backward passes while maintaining higher precision for parameter updates.

The On-Chip Learning Engine 3190 further comprises a Feedback Buffer 3194 (e.g. with a capacity of 512 MB) that is configured to store historical outcomes, state-action-reward trajectories, and experience tuples used for experience replay and offline learning. The Feedback Buffer 3194 may implement prioritized experience replay that samples important experiences more frequently, hindsight experience replay that relabels failed attempts as successful attempts toward different goals, and trajectory storage supporting episodic reinforcement learning.

In operation, the BPU 3100 functions as an integrated system providing artificial general intelligence through coordinated operation of its subsystems. Input data enters through the I/O and Interface Controllers 3170 and is analyzed by the State Machine Controller 3111 in the Central Executive Core 3110. The State Machine Controller 3111 evaluates task characteristics and determines the appropriate processing strategy.

For tasks requiring fast experiential reasoning, the State Machine Controller 3111 directs processing to the Language Processing Unit 3120. The Task Scheduler 3112 allocates computational resources, and the LPU 3120 generates one or more outputs using its Transformer Cores 3121, Attention Engines 3122, and/or Agent Execution Units 3125, accessing context from the Context Memory 3126 and episodic memory as needed.

For tasks requiring rigorous analytical reasoning grounded in physical reality, the State Machine Controller 3111 directs processing to the WPU 3130. The WPU 3130 employs its Physics Compute Cores 3131, Math Coprocessors 3132, Differential Equation Solvers 3133, and/or Simulation Engines 3134 to compute one or more outputs based on scientific principles, accessing domain knowledge from the Rule Database 3138.

For tasks benefiting from both experiential and analytical reasoning, the State Machine Controller 3111 directs processing along a hybrid pathway where both the LPU 3120 and WPU 3130 operate in parallel or sequential cooperation. The Interconnect Fabric 3150 enables efficient data exchange between processing units through the cache-coherent unified memory system.

Outputs from the LPU 3120 and the WPU 3130 are directed to the Integration and Validation Unit 3160, which merges results using the Result Blending Engine 3161, checks consistency using the Consistency Checker 3162, validates constraint satisfaction using the Validation Accelerator 3163, and computes confidence scores using the Confidence Scorer 3164, resulting in a validated output. The validated output is transmitted through the I/O and Interface Controllers 3170 to external systems or users.

Outcome feedback regarding task success, user satisfaction, and performance metrics is processed by the On-Chip Learning Engine 3190. The Reward Calculator 3191 computes reward signals, the Backpropagation Engine 3193 computes parameter gradients, and the Weight Update Unit 3192 adjusts parameters of the State Machine Controller 3111, the LPU 3120, and the WPU 3130. The Feedback Buffer 3194 stores experience for offline learning and analysis.

The Power Management Unit 3113 continuously monitors workload across processing units and dynamically adjusts power delivery and operating frequencies to optimize energy efficiency while meeting performance requirements. The Clock Distribution network 3114 maintains timing synchronization across all subsystems of the BPU 3100.

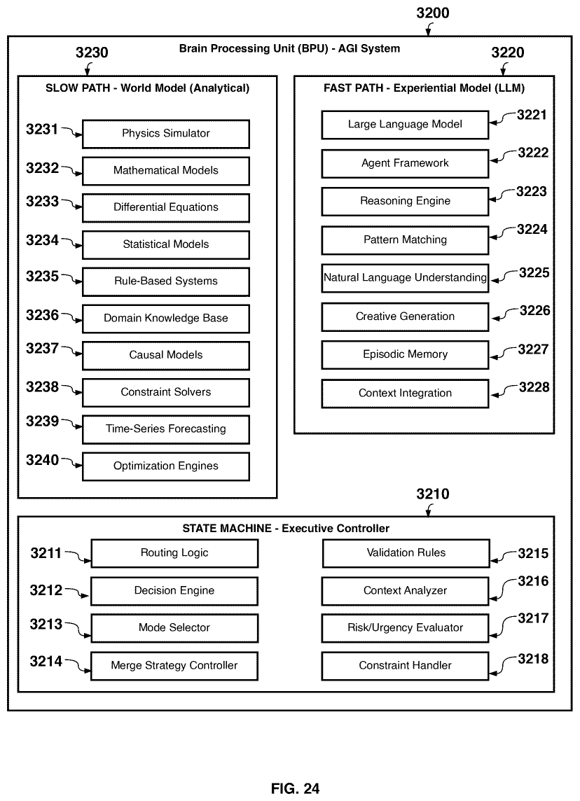

Referring now to FIG. 24, an illustration of the three parts of a BPU system 3200, according to an embodiment of the invention, with their internal components is presented. The BPU system 3200 comprises a State Machine subsystem 3210 serving as the Executive Controller for the entire system. The State Machine subsystem 3210 embodies the metacognitive capability analogous to executive function in human cognition, determining how cognitive resources are allocated between experiential and analytical processing modes.

The State Machine subsystem 3210 comprises a Routing Logic 3211 component that is configured to determine the appropriate processing pathway or combination of pathways for incoming tasks based on analyzed task characteristics. The Routing Logic 3211 implements one or more of decision trees, rule-based systems, or learned classifiers that map from task features to processing strategies. The Routing Logic 3211 considers factors including, but not limited to, task domain (e.g. linguistic vs. quantitative vs. physical), complexity indicators (e.g. problem dimensionality, constraint count, variable count), urgency signals (e.g. explicit deadlines, user patience indicators), and resource availability (e.g. current load on processing units, memory availability).

The State Machine subsystem 3210 further comprises a Decision Engine 3212 component that is configured to implement decision-making algorithms that evaluate multiple factors simultaneously to select optimal processing strategies. The Decision Engine 3212 may implement multi-criteria decision analysis using one or more methods such as weighted sum models, analytic hierarchy process (AHP), or learned utility functions.

The State Machine subsystem 3210 further comprises a Mode Selector 3213 component that is configured to choose between three primary processing modes: fast experiential processing utilizing the Language Processing Unit; slow analytical processing utilizing the World Processing Unit; or hybrid processing engaging both units simultaneously or sequentially. The Mode Selector 3213 implements a trained policy that has learned from historical data which modes perform best for different task categories.

The State Machine subsystem 3210 further comprises a Merge Strategy Controller 3214 component that is configured to determine how outputs from multiple processing subsystems should be combined when both an LPU and a WPU generate results. The Merge Strategy Controller 3214 selects among integration approaches including, but not limited to, weighted combination (where weights may be fixed, adaptive, or learned), sequential refinement (where one model's output serves as input or constraint for another model), ensemble voting (for classification or discrete choice tasks), or attention-based blending (where a neural network learns to weight contributions based on input features and intermediate results).

The State Machine subsystem 3210 further comprises a Validation Rules 3215 component that is configured to store and enforce validation criteria that outputs must satisfy before being delivered to users. The Validation Rules 3215 maintain repositories of constraints organized by, for example, domain, task type, and criticality level. Rules may include hard constraints that must never be violated (physical laws, safety requirements, regulatory mandates) and soft constraints that should be optimized (preferences, best practices, efficiency targets). The Validation Rules 3215 component implements rule engines capable of evaluating complex logical expressions, numerical constraints, and semantic constraints.

The State Machine subsystem 3210 further comprises a Context Analyzer 3216 component that is configured to extract and interpret contextual information from inputs. The Context Analyzer 3216 may be operable to process one or more of temporal context (e.g. time of day, recency of events, historical trends), domain context (e.g. subject matter, industry, application area), user context (e.g. user identity, preferences, expertise level, authorization level), and environmental context (e.g. available resources, system load, network conditions). The Context Analyzer 3216 maintains context representations that inform routing decisions and processing strategies.

The State Machine subsystem 3210 further comprises a Risk/Urgency Evaluator 3217 component that is configured to assess the risk level and time sensitivity of tasks to inform routing decisions. The Risk/Urgency Evaluator 3217 analyzes task characteristics to estimate one or more of potential consequences of errors (e.g. safety risks, financial losses, reputational damage, legal liability) and urgency indicators (e.g. explicit deadlines, implicit time expectations, downstream dependencies). High-risk tasks may be routed to analytical processing with rigorous validation, while low-risk urgent tasks may be routed to fast experiential processing.

The State Machine subsystem 3210 further comprises a Constraint Handler 3218 component processes and manages constraints that must be satisfied during task execution. The Constraint Handler 3218 categorizes constraints into one or more types, including, but not limited to, equality constraints (e.g. equations that must be satisfied exactly), inequality constraints (e.g. bounds that must not be exceeded), logical constraints (e.g. Boolean conditions that must be true), and optimization constraints (e.g. objectives to be minimized or maximized). The Constraint Handler 3218 transforms constraints into forms suitable for different processing units and tracks constraint satisfaction throughout processing.

The BPU system 3200 further comprises a Fast Path subsystem 3220 implementing an Experiential Model based on language processing and pattern recognition. The Fast Path subsystem 3220 comprises a Large Language Model (LLM) 3221 that is configured to implement a transformer-based neural network trained on extensive text corpora to understand and generate natural language. The LLM 3221 may comprise multi-layer transformer architectures with self-attention mechanisms, feed-forward networks, layer normalization, and residual connections. The LLM 3221 maintains learned parameters (weights and biases) numbering in the billions to trillions, encoding statistical patterns from training data. The LLM 3221 supports various capabilities including text completion, question answering, summarization, translation, code generation, and conversational interaction.

The Fast Path subsystem 3220 further comprises an Agent Framework 3222 that is configured to provide infrastructure for autonomous agent operations extending beyond simple language generation. The Agent Framework 3222 implements goal-directed planning using methods such as tree search, forward chaining, backward chaining, or learned planning policies. The Agent Framework 3222 may be operable to support tool use, enabling the agent to invoke external functions, execute code, query databases, call APIs, and interact with external systems. The Agent Framework 3222 may implement action selection mechanisms, monitor action outcomes, and adapt plans based on feedback.

The Fast Path subsystem 3220 further comprises a Reasoning Engine 3223 component that is configured to perform logical inference, common-sense reasoning, and chain-of-thought processing. The Reasoning Engine 3223 may implement various reasoning modalities including, but not limited to, deductive reasoning (e.g. deriving specific conclusions from general premises), inductive reasoning (e.g. inferring general principles from specific observations), abductive reasoning (e.g. inferring most likely explanations for observations), and analogical reasoning (e.g. transferring solutions from similar situations). The Reasoning Engine 3223 may support multi-step reasoning chains that decompose complex problems into simpler sub-problems.

The Fast Path subsystem 3220 further comprises a Pattern Matching 3224 component that is configured to identify similarities between current inputs and previously encountered situations stored in the model's learned representations. The Pattern Matching 3224 component may implement one or more of similarity metrics in high-dimensional embedding spaces, nearest-neighbor search using approximate methods (e.g. locality-sensitive hashing, hierarchical navigable small world graphs), and pattern retrieval based on partial cues. The Pattern Matching 3224 component enables the system to recognize familiar problem types and apply appropriate solution strategies.

The Fast Path subsystem 3220 further comprises a Natural Language Understanding 3225 component that is configured to parse, interpret, and extract meaning from natural language inputs across multiple languages and domains. The Natural Language Understanding 3225 component may be operable to perform tasks including, but not limited to, tokenization (e.g. segmenting text into words or sub-words), part-of-speech tagging, syntactic parsing (e.g. identifying grammatical structure), semantic role labeling (e.g. identifying who did what to whom), named entity recognition (e.g. identifying people, places, organizations, dates), coreference resolution (e.g. linking pronouns to referents), and intent classification.

The Fast Path subsystem 3220 further comprises a Creative Generation 3226 component that is configured to produce novel outputs including text, code, designs, and solutions by combining and extrapolating from learned patterns. The Creative Generation 3226 component may implement generative capabilities using autoregressive generation (e.g. predicting next tokens given previous tokens), sampling strategies (e.g. temperature sampling, top-k sampling, nucleus sampling), and/or controllable generation (e.g. conditioning outputs on specified attributes or constraints). The Creative Generation 3226 component supports diverse creative tasks including story generation, dialogue writing, poetry composition, music generation, and design synthesis.

The Fast Path subsystem 3220 further comprises an Episodic Memory 3227 component configured to store and retrieve information about previous interactions, conversations, and task executions to maintain continuity and context across sessions. The Episodic Memory 3227 may implement one or more memory structures that at least one of organize experiences temporally, maintain associations between related episodes, and support both temporal queries (e.g. what happened when) and semantic queries (e.g. find episodes about a particular topic). The Episodic Memory 3227 component implements forgetting mechanisms that gradually reduce accessibility of old or irrelevant information while preserving important memories.

The Fast Path subsystem 3220 further comprises a Context Integration 3228 component that is configured to incorporate relevant contextual information from episodic memory and external sources into current processing operations. The Context Integration 3228 component may implement one or more of attention mechanisms that selectively retrieve and weight relevant context, context windowing that maintains appropriate-sized contexts for language model processing, and context compression that summarizes or abstracts lengthy histories into compact representations maintaining essential information.

The BPU system 3200 further comprises a Slow Path subsystem 3230 that is configured to implement a World Model based on analytical, mathematical, and physics-based reasoning. The World Model provides the critical “world map” of physical reality that grounds the language-based processing of the Fast Path subsystem 3220. The Slow Path subsystem 3230 comprises a Physics Simulator component 3231 configured to model physical systems and phenomena according to established laws of physics. The Physics Simulator 3231 implements computational models spanning multiple domains including, but not limited to, classical mechanics (e.g. Newtonian dynamics, Lagrangian mechanics, Hamiltonian mechanics), fluid dynamics (e.g. Navier-Stokes equations, Euler equations, computational fluid dynamics), thermodynamics (e.g. heat transfer, phase transitions, chemical equilibria), electromagnetism (e.g. Maxwell's equations, electromagnetic wave propagation, circuit analysis), structural mechanics (e.g. stress analysis, deformation, vibration modes), and quantum mechanics at appropriate scales (e.g. Schrodinger equation, density functional theory for molecular systems). The Physics Simulator 3231 employs one or more numerical methods including, but not limited to, finite difference methods, finite element methods, finite volume methods, boundary element methods, and particle-based methods (e.g. molecular dynamics, smoothed particle hydrodynamics). The Physics Simulator 3231 provides physically accurate predictions of system behavior under specified initial conditions and boundary conditions.

The Slow Path subsystem 3230 further comprises a Mathematical Models 3232 component that is configured to implement one or more mathematical frameworks representing real-world systems beyond purely physical models. The Mathematical Models 3232 component may include one or more of algebraic models (e.g. systems of polynomial equations, matrix equations), geometric models (e.g. computational geometry, geometric optimization), graph models (e.g. network flow, graph algorithms, social network analysis), probabilistic models (e.g. Bayesian networks, Markov models, probabilistic graphical models), and stochastic models (e.g. random processes, Monte Carlo methods, queueing theory).

The Slow Path subsystem 3230 further comprises a Differential Equations 3233 component configured to formulate and solve ordinary differential equations (ODEs) and partial differential equations (PDEs) describing temporal and spatial evolution of systems. The Differential Equations 3233 component may be configured to implement solvers for one or more of initial value problems (e.g. ODEs with specified initial conditions), boundary value problems (e.g. ODEs or PDEs with boundary conditions), eigenvalue problems, and inverse problems (e.g. inferring parameters from observed behavior). The Differential Equations 3233 component may be configured to implement numerical integration methods including, but not limited to, explicit methods (e.g. Euler, Runge-Kutta family), implicit methods (e.g. backward Euler, backward differentiation formulas, implicit Runge-Kutta), adaptive methods (e.g. adaptive timestep selection based on error estimates), and specialized methods for stiff equations (e.g. equations with widely varying timescales).

The Slow Path subsystem 3230 further comprises a Statistical Models 3234 component that is configured to implement statistical and probabilistic models for data analysis, prediction, and uncertainty quantification. The Statistical Models 3234 component comprises one or more of regression models (e.g. linear regression, logistic regression, generalized linear models, generalized additive models), time series models (e.g. ARIMA, SARIMA, state space models, GARCH), survival analysis models, hierarchical models, and Bayesian inference frameworks. The Statistical Models 3234 component may be operable to provide one or more of point estimates, confidence intervals, prediction intervals, and posterior distributions quantifying uncertainty in estimates and predictions.

The Slow Path subsystem 3230 further comprises Rule-Based Systems 3235 that are configured to apply deterministic rules derived from domain expertise, regulatory standards, safety protocols, and logical axioms. The Rule-Based Systems 3235 may be configured to implement one or more of production rule systems (e.g. if-then rules), decision tables, expert system shells, and logic programming frameworks (e.g. Prolog-style inference). The Rule-Based Systems 3235 may be operable to perform one or more of forward chaining (e.g. data-driven reasoning from facts to conclusions), backward chaining (e.g. goal-driven reasoning from desired conclusions to supporting facts), and conflict resolution when multiple rules apply.

The Slow Path subsystem 3230 further comprises a Domain Knowledge Base 3236 that is operable to store structured knowledge about specific domains (e.g. scientific facts, engineering principles, medical knowledge, financial regulations, legal statutes, and industry-specific standards). The Domain Knowledge Base 3236 may be configured to implement one or more knowledge representation formalisms including, but not limited to, semantic networks, frames, ontologies (e.g. OWL, RDF), and description logics. The Domain Knowledge Base 3236 may be operable to support queries, reasoning over knowledge (e.g. inference of implicit facts from explicit facts), knowledge integration (e.g. merging knowledge from multiple sources), and knowledge updates (e.g. incorporating new information while maintaining consistency).

The Slow Path subsystem 3230 further comprises a Causal Models 3237 component that is configured to implement one or more frameworks for representing and reasoning about causal relationships. The Causal Models 3237 may represent causal structures using directed acyclic graphs (DAGs) where edges represent causal influences, implement structural causal models (SCMs) combining graphical models with structural equations, support interventional reasoning (e.g. predicting effects of interventions that change the system), and/or enable counterfactual reasoning (e.g. answering what-if questions about alternative scenarios).

The Slow Path subsystem 3230 further comprises a Constraint Solvers 3238 component that is configured to find solutions satisfying specified constraints using various computational techniques. The Constraint Solvers 3238 may be configured to implement constraint satisfaction problem (CSP) solving (e.g. using backtracking search with constraint propagation, arc consistency algorithms, and variable/value ordering heuristics). The Constraint Solvers 3238 may be configured to implement one or more of linear programming (e.g. simplex method, interior point methods), integer programming (e.g. branch-and-bound, cutting planes), mixed-integer linear programming (MILP), and mixed-integer nonlinear programming (MINLP).

The Slow Path subsystem 3230 further comprises a Time-Series Forecasting 3239 component that is configured to predict future values of temporal sequences using statistical and machine learning methods. The Time-Series Forecasting 3239 may be configured to implement one or more of classical methods (e.g. moving averages, exponential smoothing), ARIMA models (autoregressive integrated moving average), SARIMA models (seasonal ARIMA), state space models (Kalman filtering), and modern machine learning methods including recurrent neural networks (e.g. LSTM, GRU), temporal convolutional networks, and transformer-based forecasting models.

The Slow Path subsystem 3230 further comprises Optimization Engines 3240 that are configured to find optimal or near-optimal solutions to objective functions subject to constraints. The Optimization Engines 3240 may implement unconstrained optimization using one or more of gradient-based methods (e.g. steepest descent, conjugate gradient, Newton's method, quasi-Newton methods, trust region methods), and constrained optimization (e.g. using penalty methods, augmented Lagrangian methods, sequential quadratic programming (SQP), and interior point methods).

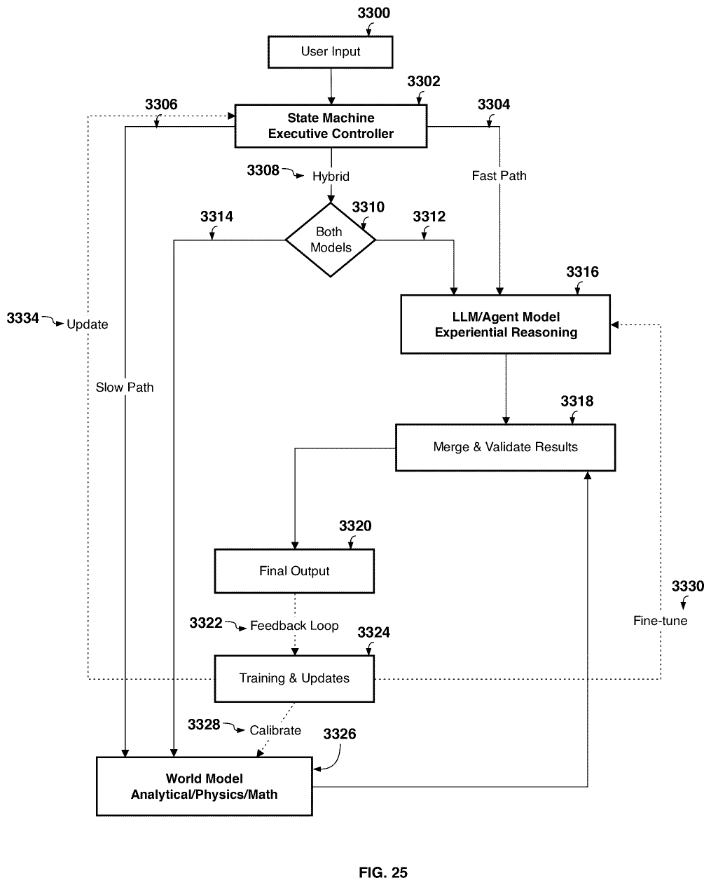

Referring now to FIG. 25, a functional block diagram of a method of operation of a Brain Processing Unit (BPU) system according to an embodiment of the invention is presented. The BPU system receives User Input 3300, which constitutes the entry point for all tasks, queries, and data to be processed by the system. The User Input 3300 may comprise diverse input modalities and formats including natural language queries expressed in text or speech, structured data in formats such as JSON, XML, CSV, or databases, unstructured documents including PDFs, images, or multimedia, executable commands specifying actions to be performed, or complex requests combining multiple input types.

The User Input 3300 may include explicit metadata specifying processing requirements, constraints, or preferences. Such metadata may indicate response time requirements (e.g. real-time, interactive, batch), accuracy requirements (e.g. acceptable error tolerances, confidence thresholds), regulatory compliance needs (e.g. applicable standards, certifications, audit requirements), risk tolerance levels (e.g. acceptable failure probabilities, safety margins), domain context (e.g. subject matter, industry, application), or user preferences (e.g. verbosity, technical level, output format).

In various embodiments, the User Input 3300 undergoes preprocessing including one or more of normalization (e.g. converting to standard formats), validation (e.g. checking for malformed inputs), sanitization (e.g. removing potentially harmful content), and feature extraction (e.g. computing numerical features characterizing the input) before being passed to subsequent processing stages.

The User Input 3300 is directed to a State Machine 3302, which functions as the executive controller for the BPU system. The State Machine 3302 is configured to analyze characteristics of the User Input 3300 across multiple dimensions. Analysis operations may include task type classification (e.g. categorizing the input as linguistic, mathematical, physical, creative, analytical), complexity assessment (e.g. estimating problem dimensionality, constraint count, search space size), domain identification (e.g. determining subject matter such as engineering, medicine, finance, science), temporal analysis (e.g. detecting urgency signals, deadlines, time dependencies), risk evaluation (e.g. assessing potential consequences of errors or failures), and/or resource estimation (e.g. predicting computational requirements, memory needs, processing time).

Based on this multidimensional analysis, the State Machine 3302 makes routing decisions to optimize processing strategy. The routing decision selects among three pathways: (1) a Fast Path routing 3304 to an LLM/Agent Model 3316 for experiential reasoning, (2) a Slow Path routing 3306 to a World Model 3326 for analytical reasoning, or (3) a Hybrid Path routing 3308 to both models 3310, 3312, 3314 operating in cooperation.

The State Machine 3302 implements a trained decision-making policy that is optimized through reinforcement learning, supervised learning from expert demonstrations, or hybrid learning approaches combining both methodologies. The policy maps from the high-dimensional space of input characteristics to discrete or continuous action spaces representing routing decisions, processing parameters, and resource allocations.

The State Machine 3302 implements state transition logic defining how system state evolves based on inputs, actions, and observations. In finite state machine implementations, the State Machine 3302 maintains a discrete set of states with defined transitions triggered by conditions. In probabilistic implementations, transitions occur with state-dependent probabilities. In neural network implementations, state representations and transition functions are learned from data.

The State Machine 3302 supports multiple operating modes that can be configured based on deployment context. These include performance mode (e.g. prioritizing response time over accuracy), accuracy mode (e.g. prioritizing correctness over speed), efficiency mode (e.g. minimizing computational cost and energy), safety mode (e.g. maximizing validation rigor for high-risk applications), and balanced mode (e.g. optimizing weighted combination of multiple objectives).

Based on the routing decision generated by the State Machine 3302, computational tasks are directed along one or more of three processing pathways, each optimized for different cognitive modes.

When the State Machine 3302 determines that experiential reasoning is appropriate (e.g. for tasks emphasizing linguistic sophistication, creative generation, common-sense reasoning, or rapid response) it routes the task along the Fast Path 3304 to the LLM/Agent Model 3316.

The Fast Path 3304 is characterized by low latency processing, typically generating initial responses within milliseconds to seconds. This pathway is optimized for tasks where speed is prioritized over mathematical rigor, including conversational interactions requiring real-time responses, content generation for creative writing or marketing, qualitative analysis and interpretation, exploratory problem solving where approximate solutions suffice, and brainstorming or ideation tasks requiring diverse candidate solutions.

The LLM/Agent Model 3316 implements experiential reasoning capabilities grounded in statistical patterns learned from massive text corpora. The LLM/Agent Model 3316 performs pattern matching in high-dimensional embedding spaces, identifying similarities between current inputs and training examples. The LLM/Agent Model 3316 generates outputs through autoregressive decoding, predicting each subsequent token conditioned on previous tokens and input context.

The LLM/Agent Model 3316 may support agent-based workflows extending beyond simple text generation. Agent capabilities may include, for example, multi-step planning decomposing complex goals into sequences of simpler actions, tool use invoking external functions or APIs to access information or perform computations, code generation and execution for implementing algorithmic solutions, memory management maintaining conversation state and retrieving relevant historical information, and self-reflection monitoring solution quality and iteratively refining outputs.

The Fast Path 3304 operates without explicit modeling of physical laws, mathematical constraints, or causal mechanisms. The LLM/Agent Model 3316 relies entirely on implicit knowledge encoded in neural network parameters during training. This enables rapid, fluent generation but provides no guarantees of physical validity, mathematical correctness, or causal accuracy.

When the State Machine 3302 determines that analytical reasoning consistent with/grounded in physical reality is required (e.g. for tasks involving quantitative computation, physical simulation, engineering design, or regulatory compliance) it routes the task along the Slow Path 3306 to the World Model 3326.

The Slow Path 3306 is characterized by higher latency processing, typically requiring seconds to hours depending on problem complexity and required accuracy. This pathway is optimized for tasks where correctness and physical validity are prioritized over speed, including engineering design and analysis, scientific computation and simulation, optimization under physical constraints, regulatory compliance verification, safety-critical applications requiring provable guarantees, and quantitative prediction with uncertainty quantification.

The World Model 3326 implements analytical reasoning capabilities based on mathematical models representing physical reality. The World Model 3326 comprises computational implementations of scientific principles including, but not limited to, physics (e.g. mechanics, thermodynamics, electromagnetism, quantum mechanics), chemistry (e.g. reaction kinetics, thermochemical equilibria, molecular modeling), biology (e.g. population dynamics, metabolic networks, physiological models), economics (e.g. supply-demand equilibria, game theory, financial models), and engineering (e.g. structural analysis, control theory, circuit analysis, fluid dynamics).

The World Model 3326 performs computations by solving mathematical equations derived from first principles rather than by pattern matching against training data. Computational methods include, for example, numerical integration of differential equations describing temporal evolution, solution of algebraic systems at equilibrium states, optimization of objective functions subject to constraints derived from physical laws, Monte Carlo simulation for stochastic systems with random components, and finite element or finite volume methods for spatial discretization of partial differential equations.

The World Model 3326 provides the “world map” grounding the linguistic reasoning of the LLM/Agent Model 3316 in physical reality. While the LLM operates in a “flat” two-dimensional linguistic space of word associations and textual patterns, the World Model operates in multi-dimensional physical space governed by conservation laws, thermodynamic constraints, structural limits, and causal mechanisms.

The Slow Path 3306 generates outputs accompanied by rigorous uncertainty quantification, sensitivity analysis identifying critical parameters, validation certificates documenting constraint satisfaction, and traceability information linking outputs to physical principles and computational methods employed.

When the State Machine 3302 determines that both experiential and analytical reasoning provide complementary value (e.g. for complex tasks requiring both creative ideation and rigorous validation, or problems benefiting from linguistic interpretation of mathematical results) it routes the task along the Hybrid Path 3308 engaging both the LLM/Agent Model 3316 and the World Model 3326.

The Hybrid Path 3308 leverages both models for their respective performance advantages relative to each other: the LLM/Agent Model 3316 provides creativity, linguistic fluency, rapid exploration, and human-like problem formulation, while the World Model 3326 provides rigor, physical validity, mathematical precision, and constraint enforcement.

Outputs from the Fast Path 3304, Slow Path 3306, or Hybrid Path 3308 are directed to a Merge & Validate component 3318. The Merge & Validate component 3318 integrates results from one or both processing models and verifying that final outputs meet quality standards and satisfy constraints.

The Merge & Validate component 3318 implements consistency checking algorithms to identify and resolve contradictions between outputs from different models. Consistency checking includes numerical consistency (e.g. verifying that quantitative predictions from LLM align with World Model computations within tolerances), logical consistency (e.g. detecting logical contradictions between linguistic statements and mathematical models), semantic consistency (e.g. ensuring that natural language descriptions accurately represent computed results), and physical consistency (e.g. verifying that linguistic descriptions do not violate physical principles established by World Model).

When inconsistencies are detected, the Merge & Validate component 3318 implements resolution strategies including prioritizing the World Model for quantitative or physical aspects (grounding outputs in rigorous computation), prioritizing the LLM for linguistic or qualitative aspects (ensuring human-readable articulation), requesting clarification or additional information from users, re-routing tasks to different processing pathways, or flagging uncertainties and presenting multiple alternative outputs.

Validation operations performed by the Merge & Validate component 3318 verify that merged outputs satisfy specified constraints. The Merge & Validate component 3318 checks hard constraints that must never be violated (e.g. physical laws such as conservation of energy, safety requirements like maximum allowable stress, regulatory mandates such as emission limits), soft constraints that should be optimized (e.g. performance objectives, efficiency targets, cost minimization), and/or user-specified constraints (e.g. preferences, requirements, acceptable ranges).

The Merge & Validate component 3318 computes confidence metrics quantifying the reliability of final outputs. Confidence scoring considers multiple factors including, but not limited to, model agreement (e.g. higher confidence when LPU and WPU produce concordant results), constraint satisfaction margins (e.g. higher confidence when outputs satisfy constraints with comfortable margins rather than barely meeting limits), historical accuracy (e.g. higher confidence for task types where the system has demonstrated consistent success), uncertainty quantification (e.g. incorporating epistemic uncertainty about model parameters and aleatoric uncertainty about random phenomena), and validation results (e.g. higher confidence when outputs pass all validation checks).

Upon successful merging and validation, the Merge & Validate component 3318 generates a Final Output 3320 that is delivered to users or downstream systems. The Final Output 3320 comprises the processed result responsive to the original User Input 3300, representing the culmination of intelligent processing that integrates experiential and analytical reasoning as appropriate for the specific task.

The Final Output 3320 includes primary content responsive to the user's request, which may take diverse forms depending on task type including natural language responses (e.g. answers to questions, generated text, dialogue, explanations), numerical results (e.g. predictions, forecasts, optimization solutions, simulation outputs), structured data (e.g. tables, databases, JSON objects, formatted reports), visualizations (e.g. plots, charts, graphs, diagrams, 3D renderings), executable artifacts (e.g. generated code, scripts, configuration files), or multimedia content (e.g. images, audio, video, interactive applications).

The BPU system implements a Feedback Loop 3322 providing continuous learning and adaptation capabilities. The Feedback Loop 3322 receives information about outcomes, performance metrics, and user feedback associated with the Final Output 3320. Feedback sources include explicit user feedback (e.g. ratings, corrections, acceptance/rejection of outputs, comparative preferences between alternatives), implicit behavioral signals (e.g. whether outputs were used, modified, or discarded, time spent reviewing outputs, downstream actions taken), task outcome indicators (e.g. whether objectives were achieved, problems solved correctly, designs functioned as intended), performance metrics (e.g. processing time, computational cost, energy consumption, resource utilization), and validation results (e.g. which constraints were satisfied, confidence scores achieved, errors detected).

The Feedback Loop 3322 is configured to update 3324 all three core components of the BPU system based on accumulated feedback, enabling system-wide improvement:
State Machine Updates: The Feedback Loop 3322 adjusts parameters of the State Machine 3302 to improve routing decisions, mode selection, and merge strategies. Updates 3334 include, for example, modifying routing policies to favor pathways that historically performed better for similar tasks, adjusting decision thresholds that determine when to use fast versus slow processing, refining merge strategy selection to choose integration methods that produced superior results, updating risk/urgency evaluation to better predict when careful validation is needed, and improving context analysis to extract more informative features for routing decisions.
LLM/Agent Model Updates: The Feedback Loop 3322 improves the capabilities of the LLM/Agent Model 3316 through continuous learning. Update mechanisms include, for example, fine-tuning 3330 on successful outputs that received positive feedback, incorporating corrections to improve accuracy on error types where failures occurred, reinforcement learning from human feedback (RLHF) using reward models trained on preference data, continual learning to adapt to new domains or tasks without catastrophic forgetting, and parameter-efficient fine-tuning methods (LoRA, prefix tuning) that adapt models while preserving general capabilities.
World Model Updates: The Feedback Loop 3322 calibrates and refines components of the World Model 3326 to improve accuracy and expand capabilities. Updates include, for example, calibrating 3328 model parameters (e.g. adjusting coefficients, tolerances, discretization parameters based on comparison between predictions and observed outcomes), incorporating new domain knowledge (e.g. adding rules, constraints, physical relationships discovered through use), refining simulation models (e.g. improving accuracy of physics simulators, mathematical solvers based on validation against ground truth), updating statistical models (e.g. re-estimating parameters as new data becomes available), and expanding model coverage (e.g. adding new physics domains, mathematical frameworks, or constraint types as needed).

The Feedback Loop 3322 implements one or both of online learning (e.g. updating models in real-time during system operation based on immediate feedback) and offline learning (e.g. periodically updating models based on accumulated experience collected in experience buffers). Online learning enables rapid adaptation to changing user needs and emerging task types. Offline learning supports more extensive model updates requiring significant computation, careful validation, and quality assurance.

In operation, the BPU system functions through the following information flow: User Input 3300 enters the system and undergoes analysis by the State Machine 3302. The State Machine 3302 evaluates input characteristics across multiple dimensions including task type, complexity, urgency, risk, domain, and constraints. Based on learned routing policies optimized through historical feedback, the State Machine 3302 selects an appropriate processing pathway.

For experiential reasoning tasks, the State Machine 3302 routes processing along the Fast Path 3304 to the LLM/Agent Model 3316, which generates outputs through pattern matching and learned linguistic capabilities. For analytical reasoning tasks requiring physical grounding, the State Machine 3302 routes processing along the Slow Path 3306 to the World Model 3326, which computes outputs based on mathematical models and scientific principles. For complex tasks benefiting from both reasoning modes, the State Machine 3302 routes processing along the Hybrid Path 3308 engaging both models in cooperation.

Outputs from selected processing pathway(s) flow to the Merge & Validate component 3318, which integrates results when multiple models were employed, checks consistency between outputs, validates constraint satisfaction, and computes confidence scores. Upon successful validation, the Merge & Validate component 3318 generates the Final Output 3320 delivered to users with accompanying metadata providing transparency.

Information about outcomes, user feedback, and performance metrics flows through the Feedback Loop 3322 to update system components. The State Machine 3302 improves routing decisions based on which pathways produced superior results. The LLM/Agent Model 3316 adapts through fine-tuning or reinforcement learning. The World Model 3326 calibrates parameters and incorporates new knowledge. This continuous learning enables progressive improvement in system capabilities and performance.

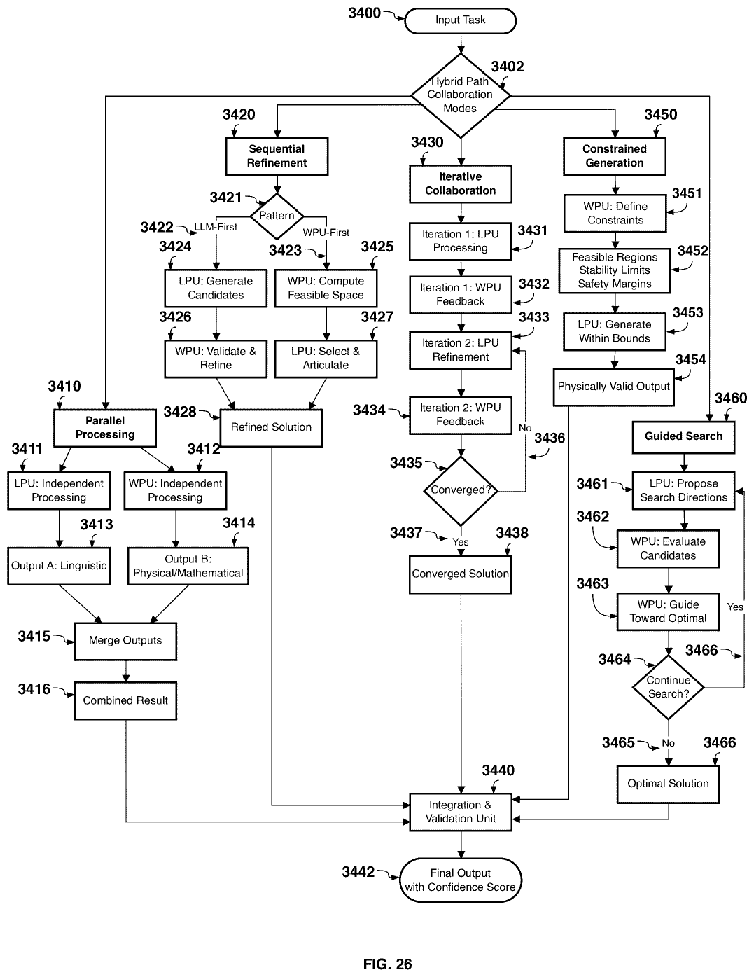

Referring now to FIG. 26, an illustration of multiple collaboration modes between models along a hybrid path 3402 is presented. The diagram depicts a plurality of operational modes within the hybrid path 3402, each representing a different architectural approach for orchestrating cooperation between the Language Processing Unit (LPU) and the World Processing Unit (WPU) to achieve artificial general intelligence through integrated experiential and analytical reasoning.

A first collaboration mode, Parallel Processing Mode 3410, illustrates simultaneous and independent processing wherein both the LPU 3411 and the WPU 3412 receive an input task 3400 concurrently and generate separate outputs without inter-model communication during processing. The LPU 3411 produces Output A 3413 comprising linguistic representations, while the WPU 3412 generates Output B 3414 comprising physical and mathematical computations. These independent outputs are subsequently directed to a Merge Operation 3415 that combines the complementary perspectives using weighted combination, ensemble methods, or attention-based blending strategies to produce a Combined Result 3416. This mode is beneficial when the LPU 3411 and the WPU 3412 provide non-overlapping insights or when ensemble combination enhances robustness and accuracy through diversity of approaches.

A second collaboration mode, Sequential Refinement Mode 3420, implements unidirectional cascaded processing wherein one model's output serves as input or constraint for the subsequent model. This mode supports two alternative processing sequences, determined at a pattern step 3421. In an LLM-First pattern 3422, the LPU initially generates candidate solutions 3424 based on experiential reasoning and pattern recognition, which are then transmitted to the WPU for validation and refinement 3426, ensuring physical validity and constraint satisfaction. Conversely, in a WPU-First pattern 3423, the WPU first computes the feasible solution space 3425 by determining boundaries defined by physical laws, conservation principles, and constraint satisfaction, thereby establishing a solution envelope within which the LPU subsequently selects and articulates solutions 3427 that are linguistically sophisticated yet physically valid. Both patterns converge to produce a Refined Solution 3428 that leverages the complementary strengths of experiential and analytical reasoning in a staged pipeline architecture.

A third collaboration mode, Iterative Collaboration Mode 3430, implements bidirectional cyclic processing wherein an LPU and a WPU alternate in an iterative refinement loop. The process commences with Iteration 1 LPU Processing 3431, generating an initial solution based on linguistic reasoning from the LPU. This output is transmitted to Iteration 1 WPU Feedback 3432, wherein the WPU evaluates the solution against physical constraints and provides feedback comprising constraint violations, feasibility assessments, or refinement suggestions. Subsequently, Iteration 2 LPU Refinement 3433 incorporates the 1 WPU Feedback 3432 to generate an improved solution, which is again subjected to Iteration 2 WPU Feedback 3434. This alternating process continues through a Convergence Decision Point 3435, which evaluates whether the solution has converged to a state satisfying both linguistic quality metrics and physical validity criteria. If convergence is not achieved 3436, the loop returns to the LPU refinement 3433 stage; if convergence is achieved 3437, the process terminates with a Converged Solution 3438 that represents an equilibrium between experiential and analytical reasoning.

A fourth collaboration mode, Constrained Generation Mode 3450, implements boundary-defined generation wherein a WPU establishes constraint boundaries 3451 prior to LPU processing. The WPU defines feasible regions, stability limits, and safety margins 3452 derived from physical laws, engineering standards, and regulatory requirements. These constraint boundaries are communicated to the LPU, which subsequently performs generation operations 3453 exclusively within the established bounds, ensuring that all generated outputs inherently satisfy physical requirements. This mode produces a Physically Valid Output 3454 without requiring post-generation validation, as the constraints are enforced during the generation process itself. This architecture is beneficial for safety-critical applications where constraint violation is unacceptable and must be prevented rather than merely detected.

A fifth collaboration mode, Guided Search Mode 3460, implements heuristic-driven exploration wherein an LPU and a WPU cooperate in an optimization search process. The LPU proposes search directions 3461 based on pattern recognition, domain heuristics, and experiential knowledge of promising solution regions. The WPU evaluates candidates 3462 using rigorous mathematical computation, physics-based simulation, and/or constraint satisfaction checking to assess solution quality objectively. Based on these evaluations, the WPU guides the search toward optimal regions 3463 by one or more of providing gradient information, ranking metrics, or feasibility assessments. A continuation decision point 3464 determines whether to continue exploration or terminate based on convergence criteria, solution quality thresholds, and/or computational budget constraints. If search continues at step 3466, the process returns to the LPU proposal 3461 stage; if terminated at step 3465, an Optimal Solution 3466 is produced representing the best solution identified through the collaborative search process.

All five collaboration modes converge their respective outputs to an Integration and Validation Unit 3440, which performs consistency checking between linguistic descriptions and mathematical results, validates outputs against physical laws and regulatory requirements, computes confidence scores based on model agreement and constraint satisfaction margins, and generates processing transparency metadata documenting which models contributed to the final output and through which collaboration mode. The validated output is then delivered as Final Output 3442 and may be accompanied by confidence metrics and provenance information, enabling users to understand the reasoning process and assess output reliability for deployment in critical applications.

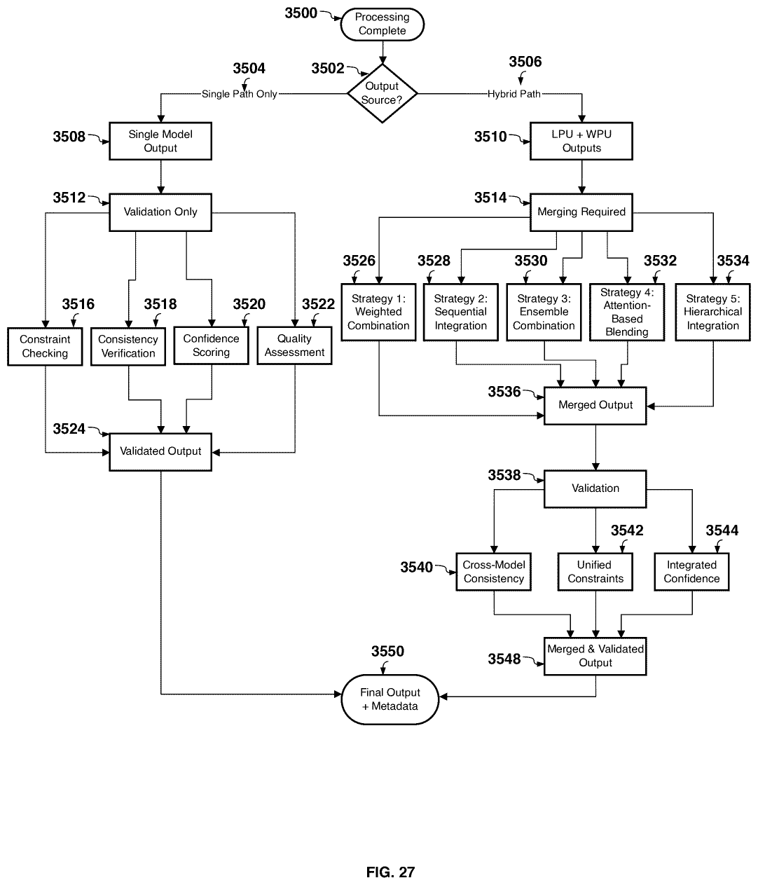

Referring now to FIG. 27, an illustration of a method of the Merge & Validate component operational modes is presented. The illustration depicts the bifurcated processing architecture that handles outputs from either single processing pathways or dual processing pathways via the Hybrid Path, illustrating the distinct operational flows for validation-only and merge-plus-validation scenarios.

Upon completion of processing operations 3500, the system evaluates an Output Source 3502 to determine whether results originate from a single processing pathway or from dual pathways requiring integration.

In a first operational mode, designated as Single Path Processing 3504, outputs are received from either a Fast Path or a Slow Path exclusively, without contribution from a complementary processing model. The Single Model Output 3508 is directed to a Validation Only operation 3512, wherein no merging is required as only a single result set exists. The validation operation comprises a plurality of parallel validation functions executing comprehensive quality and compliance checks.

A first validation function, Constraint Checking 3516, verifies that outputs satisfy all specified requirements including physical laws derived from first principles, regulatory standards mandated by governing bodies, safety margins defined by engineering specifications, business rules established by organizational policies, and user preferences specified in the input requirements. A second validation function, Consistency Verification 3518, examines internal consistency of outputs to detect contradictions, ensures numerical values fall within valid ranges defined by domain constraints, and/or validates logical coherence of reasoning chains and conclusions. A third validation function, Confidence Scoring 3520, computes reliability metrics based on model uncertainty quantified through one or more of ensemble disagreement or probabilistic outputs, historical accuracy determined from prior performance on similar tasks, and validation results indicating degree of constraint satisfaction. A fourth validation function, Quality Assessment 3522, evaluates outputs against task-specific quality criteria including accuracy, completeness, relevance, and adherence to formatting requirements.

Upon completion of all validation functions, the system produces a Validated Output 3524 that has been certified to meet all applicable standards and constraints. This validated output is then transmitted to the Final Output stage 3550.

In a second operational mode, designated as Hybrid Path Processing 3506, outputs are received from both the LPU and the WPU 3510 operating in cooperative modes, necessitating integration of complementary results. The dual outputs, comprising LPU Output of linguistic nature and WPU Output of physical and mathematical nature, are directed to a Merging Required operation 3514, which combines the disparate output types into a unified result.

The system implements a plurality of merging strategies, selectable based on task characteristics, output types, and learned performance patterns:
Strategy 1: Weighted Combination 3526 combines outputs using learned or adaptive weights, applying weighted averaging for continuous-valued outputs such as numerical predictions, vectors, or matrices, and weighted voting for discrete outputs such as classifications or selections. Weights may be fixed based on domain expertise, adapted dynamically based on input characteristics, or learned through training on historical data.
Strategy 2: Sequential Integration 3528 employs one model's output to inform or constrain the other model's processing in a cascaded architecture. Common patterns include using the World Model's feasibility analysis to constrain the LLM's solution generation, ensuring physical validity, or employing the LLM's natural language explanation to enhance interpretability of the World Model's numerical results.
Strategy 3: Ensemble Combination 3530 generates and combines multiple outputs using ensemble methods drawn from machine learning theory. Implemented techniques include majority voting for classification tasks, stacking wherein a meta-model is trained to optimally combine base model outputs, and boosting wherein models are iteratively trained on errors of previous models to improve overall accuracy.
Strategy 4: Attention-Based Blending 3532 employs a neural network implementing an attention mechanism that learns to dynamically weight contributions from different models based on input features and intermediate processing results. The attention mechanism identifies which model demonstrates greater reliability for different aspects of the task, enabling adaptive weighting that responds to contextual factors.
Strategy 5: Hierarchical Integration 3534 combines outputs at multiple levels of abstraction in a hierarchical architecture. Low-level features extracted from different models are first combined into mid-level representations capturing integrated information, which are subsequently combined into high-level outputs representing the final unified result. This multi-scale integration preserves information at different granularities.

All merging strategies produce a Merged Output 3536 representing the integrated result of cooperative processing. This merged output is then directed to Post-Merge Validation 3538, which performs three validation operations specific to dual-model processing.

A first post-merge validation operation, Cross-Model Consistency Check 3540, verifies agreement between linguistic descriptions generated by the LPU and mathematical results computed by the WPU, detecting inconsistencies that may indicate processing errors or model limitations. A second operation, Unified Constraint Verification 3542, validates that the merged output satisfies all constraints applicable to both models, ensuring the integration process has not introduced constraint violations. A third operation, Integrated Confidence Scoring 3544, computes an overall confidence metric reflecting agreement between models, individual model uncertainties, and validation results.

Upon completion of post-merge validation, the system produces a Merged & Validated Output 3548 that has been both integrated and certified. This output is transmitted to the Final Output stage 3550.

Both processing pathways converge at the Final Output with Metadata stage 3550, which delivers results to the user. The metadata comprises documentation of the processing path employed (Fast Path, Slow Path, or Hybrid Path), identification of the merge strategy used when applicable (Strategies 1-5), the computed confidence score reflecting output reliability, and validation status indicating successful satisfaction of all constraints and quality criteria.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

The claims in the instant application are different than those of the parent application or other related applications. Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. A method for processing artificial intelligence (AI) user requests using a system that comprises both an experiential system and an analytical system, comprising:
receiving a user input from a user device;
performing a routing analysis on the user input on a basis of a plurality of characteristics;
making a routing decision based on the routing analysis to send the user input to one or both of:
an experiential system; and
an analytical system;
routing the user input to at least one of the experiential system and the analytical system responsive to the routing decision;
receiving one or more outputs from at least one of the experiential system and the analytical system;
generating a final result by performing a result validation procedure on the one or more outputs; and
transmitting the final result to the user device.

2. The method of claim 1 wherein the plurality of characteristics comprises at least two of:
task type classification;
complexity assessment;
domain identification;
temporal analysis;
risk evaluation; and
resource estimation.

3. The method of claim 1 wherein the routing analysis is optimized by at least one of:
supervised learning; or
a combination of reinforcement learning and supervised learning.

4. The method of claim 1 wherein the routing analysis is performed in at least one of:
a performance mode configured to prioritize response time;
an accuracy mode configured to prioritize accuracy;
an efficiency mode configured to minimize at least one of computational cost and energy;
a safety mode configured to maximize validation rigor; and
a balanced mode configured to optimize weighted combination of multiple objectives.

5. The method of claim 1 wherein the experiential system is configured to operate without explicit modeling of physical laws, mathematical constraints, or causal mechanisms.

6. The method of claim 1 wherein the analytical system comprises two or more computational implementations of scientific principles directed to:
physics;
chemistry;
biology;
economics; and
engineering.

7. The method of claim 1 wherein the analytical system is operable to generate an output comprising at least one of:
an uncertainty quantification;
a sensitivity analysis;
a validation certificate;
a documenting constraint satisfaction; and
traceability information.

8. The method of claim 1 wherein the result validation procedure comprises implementing one or more consistency checking algorithms directed to:
numerical consistency;
logical consistency;
semantic consistency; and
physical consistency.

9. The method of claim 1 wherein the result validation procedure is operable to compute one or more confidence metrics comprising at least one of:
model agreement;
constraint satisfaction margins;
historical accuracy;
uncertainty quantification; and
validation results.

10. The method of claim 1 wherein the result validation procedure is operable to merge a first output received from the experiential system comprised by the one or more outputs and a second output received from the analytical system comprises by the one or more outputs.

11. The method of claim 1 wherein the experiential system comprises a large language model.

12. The method of claim 1 further comprising executing a feedback procedure comprising at least one of:
adjusting one or more parameters for performing the routing analysis;
updating the experiential system; and
updating the analytical system.

13. The method of claim 12 wherein the feedback procedure is performed responsive to at least one of:
outcomes;
performance metrics; and
user feedback associated with the final result.

14. A system-on-a-chip for processing artificial intelligence user requests comprising:
an experiential system operable to generate a first output from a user input and;
an analytical system operable to generate a second output from the user input;
a central executive code configured to:
perform a routing analysis on the user input on a basis of a plurality of characteristics;
make a routing decision based on the routing analysis to send the user input to one or both of the experiential system and the analytical system; and
route the user input to at least one of the experiential system and the analytical system responsive to the routing decision;
an integration and validation unit configured generate a final result by performing a result validation procedure on at least one of the first output and the second output; and
an interface controller configured to:
receive the user input from a user device; and
transmit the final result to the user device.

15. The system-on-a-chip of claim 14 wherein the plurality of characteristics comprises at least two of:
task type classification;
complexity assessment;
domain identification;
temporal analysis;
risk evaluation; and
resource estimation.

16. The system-on-a-chip of claim 14 wherein the routing analysis is optimized by at least one of:
reinforcement learning;
supervised learning; or
a combination of reinforcement learning and supervised learning.

17. The system-on-a-chip of claim 14 wherein the routing analysis is performed in at least one of:
a performance mode configured to prioritize response time;
an accuracy mode configured to prioritize accuracy;
an efficiency mode configured to minimize at least one of computational cost and energy;
a safety mode configured to maximize validation rigor; and
a balanced mode configured to optimize weighted combination of multiple objectives.

18. The system-on-a-chip of claim 14 wherein the experiential system is configured to operate without explicit modeling of physical laws, mathematical constraints, or causal mechanisms.

19. The system-on-a-chip of claim 14 wherein the analytical system comprises two or more computational implementations of scientific principles directed to:
physics;
chemistry;
biology;
economics; and
engineering.

20. The system-on-a-chip of claim 14 wherein the analytical system is operable to generate an output comprising at least one of:
an uncertainty quantification;
a sensitivity analysis;
a validation certificate;
a documenting constraint satisfaction; and
traceability information.

21. The system-on-a-chip of claim 14 wherein the integration and validation unit is further configured to implement one or more consistency checking algorithms directed to:
numerical consistency;
logical consistency;
semantic consistency; and
physical consistency.

22. The system-on-a-chip of claim 14 wherein the integration and validation unit is further configured to compute one or more confidence metrics comprising at least one of:
model agreement;
constraint satisfaction margins;
historical accuracy;
uncertainty quantification; and
validation results.

23. The system-on-a-chip of claim 14 wherein the integration and validation unit is further configured to merge a first output received from the experiential system comprised by the one or more outputs and a second output received from the analytical system comprises by the one or more outputs.

24. The system-on-a-chip of claim 14 wherein the experiential system comprises a large language model.

25. The system-on-a-chip of claim 14 further comprising a learning engine operable to execute a feedback procedure comprising at least one of:
adjusting one or more parameters for performing the routing analysis;
updating the experiential system; and
updating the analytical system.

26. The system-on-a-chip of claim 25 wherein the feedback procedure is performed responsive to at least one of:
outcomes;
performance metrics; and
user feedback associated with the final result.

27. A system for processing artificial intelligence user requests comprising:
means for receiving a user input from a user device;
means for performing a routing analysis on the user input on a basis of a plurality of characteristics;
means for making a routing decision based on the routing analysis to send the user input to one or both of an experiential system and an analytical system;
means for routing the user input to at least one of the experiential system and the analytical system responsive to the routing decision;
means for receiving one or more outputs from at least one of the experiential system and the analytical system;
means for generating a final result by performing a result validation procedure on the one or more outputs; and
means for transmitting the final result to the user device.

28. The system of claim 27 wherein the routing analysis is optimized by at least one of:
supervised learning; or
a combination of reinforcement learning and supervised learning.

29. The system of claim 27 wherein the validation procedure is operable to merge a first output received from the experiential system comprised by the one or more outputs and a second output received from the analytical system comprises by the one or more outputs.

30. The system of claim 27 further comprising means for executing a feedback procedure comprising at least one of:
adjusting one or more parameters for performing the routing analysis;
updating the experiential system; and
updating the analytical system.
